(19) United States
(12) Patent Application Publication
(10) Pub. No.: US 2016/0209770 A1
(43) Pub. Date: Jul. 21, 2016

(54) TWO-COMPONENT DEVELOPER FOR ELECTROSTATIC LATENT IMAGE DEVELOPMENT

(71) Applicant: Konica Minolta, Inc., Tokyo (JP)

(72) Inventors: Kosuke NAKAMURA, Tokyo (JP); Satoshi UCHINO, Tokyo (JP); Shinya OBARA, Tokyo (JP)

(21) Appl. No.: 14/991,299

(22) Filed: Jan. 8, 2016

(30) Foreign Application Priority Data
Jan. 19, 2015 (JP) 2015-008022

(51) Int. Cl. G03G 9/113; G03G 9/08; G03G 9/093

(52) U.S. Cl. CPC G03G 9/1133; G03G 9/09385; G03G 9/0827; G03G 9/0825; G03G 9/0823

(57) ABSTRACT

A two-component developer for electrostatic latent image development includes: toner particles obtained in such a manner that an external additive is attached to a surface of toner base particles containing at least a binder resin; and carrier particles obtained in such a manner that a surface of core particles is coated with a resin for coating, wherein the toner particles have a volume-average particle size of 3 μm or more and 5 μm or less, the core particles have porosity of 8% or less, and the carrier particles have a volume-average particle size of 15 μm or more and 30 μm or less, volume resistivity of 1×10⁸ Ω·cm or more and 1×10¹⁰ Ω·cm or less, a true specific gravity of 4.25 g/cm³ or more and 5 g/cm³ or less, and a shape factor SF-1 of 105 or more and 125 or less.

The entire disclosure of Japanese Patent Application No. 2015-008022 filed on Jan. 19, 2015 including description, claims, drawings, and abstract are incorporated herein by reference in its entirety.

### BACKGROUND OF THE INVENTION

1. Field of the Invention

The present invention relates to a two-component developer for electrostatic latent image development.

2. Description of the Related Art

With the spread of digital printing, high-image quality and high stability have been increasingly required. In the field of toners for electrostatic latent image development, furthermore, a method of lowering a melting temperature or a melt viscosity of a binder resin constituting the toners from the viewpoint of energy saving so as to reduce energy required for fixing or a method of reducing energy required for fixing by reducing the toner amount on a sheet is being considered. In the former method, a crystalline resin is employed, and thus the melt viscosity can be rapidly lowered at a temperature higher than a melting point and saving of fixing energy can be achieved. Furthermore, in the latter method, the size of toner particles becomes smaller, and thus the surface area of the toner particles increases, a sheet can be concealed by a small amount of toner and energy required for fixing can be reduced without deterioration of an image density. In addition, when the size of toner particles becomes smaller, reproducibility of fine latent image is also excellent, and thus both of energy saving and high image quality can be achieved.

For example, two-component developers formed in combination of toners having a small particle size of about 3 to 10 μm and carriers are disclosed in JP 2005-181486 A, JP 2004-348029 A, WO 2010-016605 A, JP 2009-169443 A, and JP 2009-192722 A.

In recent years, the output demand for graphics or the like increases and the printing output of high image density has been increasing. However, techniques disclosed in JP 2005-181486 A, JP 2004-348029 A, WO 2010-016605 A, JP 2009-169443 A, and JP 2009-192722 A had problems that the charge amount of toner insufficiently rose and image quality was deteriorated in continuous printing with a high image density.

### SUMMARY OF THE INVENTION

Accordingly, the present invention has been made in view of the above circumstances, and an object thereof is to provide a two-component developer for electrostatic latent image development that can improve the rising of the charge amount of toner particles and form a high-quality image in continuous printing with a high image density in particular.

The inventors have extensively studied in order to solve the above problems. As a result, the inventors found that the above problems were solved by a two-component developer obtained in combination of carrier particles having a volume-average particle size, porosity of core particles, volume resistivity, a true specific gravity, and a shape factor within a certain range and toner particles having a small particle size, thereby completing the present invention.

To achieve the abovementioned object, according to an aspect, a two-component developer for electrostatic latent image development reflecting one aspect of the present invention comprises: toner particles obtained in such a manner that an external additive is attached to a surface of toner base particles containing at least a binder resin; and carrier particles obtained in such a manner that a surface of core particles is coated with a resin for coating, wherein the toner particles have a volume-average particle size of 3 μm or more and 5 μm or less, the core particles have porosity of 8% or less, and the carrier particles have a volume-average particle size of 15 μm or more and 30 μm or less, volume resistivity of 1×10⁸ Ω·cm or more and 1×10¹⁰ Ω·cm or less, a true specific gravity of 4.25 g/cm³ or more and 5 g/cm³ or less, and a shape factor SF-1 of 105 or more and 125 or less.

### DESCRIPTION OF THE PREFERRED EMBODIMENTS

Hereinafter, an embodiment of the present invention will be described with reference to the drawings. However, the scope of the invention is not limited to the illustrated examples.

In this description, “X to Y” indicating a range means “X or more and Y or less”, and, unless otherwise specified, operation, physical properties, and the like are measured at room temperature (20 to 25° C.) and relative humidity of 40 to 50% RH.

A two-component developer for electrostatic latent image development (hereinafter, the “two-component developer for electrostatic latent image development” is simply also referred to as a “two-component developer”) according to the present invention includes: toner particles obtained in such a manner that an external additive is attached to a surface of toner base particles containing at least a binder resin; and carrier particles obtained in such a manner that a surface of core particles is coated with a resin for coating. Then, the toner particles have a volume-average particle size of 3 μm or more and 5 μm or less, the core particles have porosity of 8% or less, and the carrier particles have a volume-average particle size of 15 μm or more and 30 μm or less, volume resistivity of 1×10⁸ Ω·cm or more and 1×10¹⁰ Ω·cm or less, a true specific gravity of 4.25 g/cm³ or more and 5 g/cm³ or less, and a shape factor SF-1 of 105 or more and 125 or less.

According to the two-component developer according to the present invention having the above configuration, the rising of the charge amount of toner particles is improved, chargeability of toner particles can be stably maintained, and density unevenness or fogging is reduced in continuous printing with a high image density in particular, so that dot reproducibility is excellent and a high-quality image can be obtained for a long period. In addition, a sleeve memory can be also reduced. Further, even under high temperature and high humidity (HH) environment or low temperature and low humidity (LL) environment, the rising of the charge amount of toner is improved and a high-quality image can be obtained for a long time.

A configuration of the two-component developer according to the present invention will be described below in more detail.

[Carrier]

The carrier particles according to the present invention are obtained in such a manner that the surface of core particles is coated with a resin for coating. The carrier particles may contain an internal additive such as a resistance adjusting agent as necessary.

The core particles and the resin for coating will be described below.

<Core Particles>

The core particles are configured by, for example, metal powders such as iron powders or various ferrites. Among these, the ferrite is preferred from the viewpoint of the fact that residual magnetization is low and preferred magnetic characteristics are obtained.

As such ferrite, for example, ferrites containing heavy metals such as Cu, Zn, Ni, and Mn, and light metal ferrites containing alkali metals or alkaline earth metals are preferred.

The ferrite is a compound represented by a general formula of (MO)x(Fe₂O₃), and the molar ratio y of Fe₂O₃ constituting the ferrite is preferably 30 mole % to 95 mole %. With the ferrite having the molar ratio y within such a range, since desired magnetization is easy to realize, it has an advantage of producing carrier particles which hardly cause adhesion between the carrier particles. M in the general formula employs metals such as manganese (Mn), magnesium (Mg), strontium (Sr), calcium (Ca), titanium (Ti), copper (Cu), zinc (Zn), nickel (Ni), aluminum (Al), silicon (Si), zirconium (Zr), bismuth (Bi), cobalt (Co), and lithium (Li). These metal atoms can be used singly or in combination of two or more kinds thereof. Above all, from the viewpoint of the fact that residual magnetization is low and preferred magnetic characteristics are obtained, manganese, magnesium, strontium, lithium, copper, or zinc is preferred, and manganese or magnesium is more preferred. That is, the core particles according to the present invention preferably employ ferrite particles containing at least one of manganese and magnesium.

The core particles may use a commercially available product and may use a synthetic product. In the case of synthesis, for example, the following method may be included.

First, an appropriate amount of a raw material of the core particles is weighed and then pulverized and mixed preferably for 0.5 hours or more and more preferably for 1 to 20 hours in a wet-type media mill, a ball mill, a vibration mill, or the like. The pulverized product thus obtained is pelletized using a press forming machine or the like, and then the pellets are preferably subjected to temporary calcination at a temperature of 700 to 1200° C. for 0.5 to 5 hours.

It may be also acceptable to pulverize the raw materials without using the press forming machine, subsequently add the pulverized product with water to form slurry and granulate the slurry using a spray dryer. After the temporary calcination, the resulting product is pulverized with a ball mill, a vibration mill, or the like, and then water and optionally a dispersant, a binder such as polyvinyl alcohol (PVA), and the like are added thereto. Thus, the viscosity is adjusted, the product is thus granulated, and main calcination is performed. A temperature of the main calcination is preferably 1000 to 1500° C., and a time of the main calcination is preferably 1 to 24 hours. When pulverization is carried out after the temporary calcination, water may be added, and the pulverization may be carried out with a wet-type ball mill, a wet-type vibration mill, or the like.

There are no particular limitations on the pulverizer such as the ball mill or vibration mill described above. However, in order to effectively and uniformly disperse the raw materials, it is preferable to use fine beads having a particle size of 1 cm or less as the medium to be used. Furthermore, a degree of pulverization can be controlled by adjusting a diameter of the beads to be used, a composition, and a pulverization time.

The calcined product thus obtained is pulverized and classified. Regarding the classification method, a particle size is adjusted to a desired particle size using conventional methods such as air classification, mesh filtration, and sedimentation.

Thereafter, if necessary, the calcined product is subjected to oxide film treatment by heating of the surface at a low temperature, whereby electrical resistance thereof can be adjusted. For the oxide film treatment, a heat treatment can be carried out, for example, at 300 to 700° C. using a general rotary type electric furnace, a batch type electric furnace, or the like. A thickness of the oxide film formed by this treatment is preferably 0.1 nm to 5 μm. When the thickness of the oxide film is within the above range, the effect of the oxide film layer is obtained and resistance does not become excessively high, so that desired characteristics can be easily obtained, which is preferable. If necessary, reduction may also be carried out before the oxide film treatment. In addition, after the classification, a low magnetic product may be separated by magnetic separation.

Porosity of the core particles to be described below can be controlled through various manners such as selection of kinds of raw materials to be blended, the ratio of the raw material to be added, the presence or absence of the temporary calcination, the temperature of the temporary calcination, the time of the temporary calcination, the amount of binder during granulation by the spray drier, the moisture content, the degree of drying, the method of calcination, the temperature of calcination, the time of calcination, the method for disintegration, and the reduction by hydrogen gas. In addition, the true specific gravity of the carrier particles can be controlled through selection of kinds of raw materials to be blended, the ratio of the raw material to be added, and the like. These controlling methods are not particularly limited, and an example will now be described.

That is, the core particles tend to have a smaller porosity when oxides are selected as the kind of the raw material to be blended compared with hydroxides or carbonates. In addition, the true specific gravity of the carrier particles tends to be small when oxides of Mn, Mg, Ca, Sr, Li, Ti, Al, Si, Zr, and Bi are selected as the raw material compared with oxides of heavy metals such as Cu, Ni and Zn. When the raw materials are ferrite particles including Mn and Mg, it is possible to control the true specific gravity even by controlling the ratio of the amount of Mn and Mg to be added.

The porosity is decreased when the temporary calcination is carried out. As the temporary calcination temperature becomes higher, the porosity becomes lower.

In granulation with the spray drier, the gap becomes smaller and the porosity becomes lower as the amount of water to be used at the time of forming slurry from the raw material. During main calcination, the porosity becomes lower as the temperature of calcination becomes higher.

In order to obtain the desired porosity of the core particles and the true specific gravity of the carrier particles, these controlling methods can be used singly or in combination. However, since various characteristics are influenced by each of the control factors, when these controlling methods are used in combination, it is possible to obtain the core particles having characteristics of the porosity and the true density as defined in the present invention.

The core particles according to the present invention have porosity of 8% or less. When the porosity exceeds 8%, the mass of the carrier is reduced, impact energy of the carrier particles to the toner particles becomes smaller, and thus the rising of the charge amount of toner particles is deteriorated. The porosity is preferably 5% or less. The lower limit value of the porosity is generally 0%. The porosity of the core particles can be measured by the following method in particular.

<<Measurement Method>>

The porosity of the core particles is obtained in such a manner that an image obtained after a cross-section of the core particles is taken by a scanning type electron microscope is analyzed using image analysis software (Image-Pro Plus manufactured by Media Cybernetics Inc.). Specifically, an area (A) of particles which are connected by a line enveloping the unevenness of the surface of the core particles is measured, and subsequently, an area (B) of a core portion contained in a screen of the core particles is measured. Here, the porosity is calculated using the following Formula (1).

[Formula 1]

Porosity (%)=(Enveloping particle area (A)−Core area (B))/Enveloping particle area (A)×100 (1)

The porosity calculated by the Formula (1) is porosity obtained in combination of a gap which is continuous from the surface of the core particles and a gap which independently exists inside the core.

More specifically, with respect to ten of core particles, images obtained after cross sections in the vicinity of the center are taken by the scanning type electron microscope are analyzed to obtain an average value. Then, the porosity can be determined from the average value.

The particle size of the core particles is preferably 13 to 30 μm in volume-based median diameter (D₅₀). When the volume-based median diameter (D₅₀) of the core particles is 30 μm or smaller, excellent image quality can be provided without deterioration of image quality, which is excellent. When the volume-based median diameter (D₅₀) of the core particles is 13 μm or larger, the occurrence in adhesion between the carrier particles can be prevented and excellent image quality having less fogging can be provided, which is excellent.

In the core particles according to the present invention, saturation magnetization is preferably in the range of 30 to 80 Am²/kg, and residual magnetization is preferably 5.0 Am²/kg or less. When the core particles having these magnetic characteristics are used, partial coagulation of the carrier particles is prevented, and a two-component developer is more uniformly dispersed onto the surface of a developer carrying member. Thus, a fine-grained toner image with no density unevenness and of being uniform can be formed.

The volume-based median diameter (D₅₀) can be measured by, for example, a laser diffraction-type particle size distribution measuring apparatus “HELOS” (manufactured by SYMPATECS Co., Ltd.) equipped with a wet disperser, and the saturation magnetization of the core particles can be measured by, for example, a “direct current magnetization characteristic automatic recorder 3257-35” (manufactured by Yokogawa Electric Corporation).

<Resin for Coating>

As a constituent unit contained in the resin for coating, it preferably contain a constituent unit derived from an alicyclic (meth)acrylic acid ester compound which is highly hydrophobic. When the resin for coating contains the constituent unit derived from the alicyclic (meth)acrylic acid ester compound, the moisture adsorption amount of the carrier particles is reduced, an environmental difference in charging property is reduced, and the deterioration of the charge amount is particularly suppressed under a high temperature and high humidity environment. In addition, since a resin containing the constituent unit derived from the alicyclic (meth)acrylic acid ester compound has appropriate mechanical strength and is appropriately worn as a coating material, it also has an advantage that the surface of the carrier particles is refreshed. In this description, the term of (meth)acrylic means acrylic or methacrylic.

Specifically, examples of alicyclic (meth)acrylic acid ester compounds may include isobornyl acrylate, dicyclopentanyl acrylate, cyclohexyl acrylate, methylcyclohexyl acrylate, trimethylcyclohexyl acrylate, t-butylcyclohexyl acrylate, cyclohexyl phenyl acrylate, cyclododecyl acrylate, adamantyl acrylate, cyclopentyl methacrylate, cyclohexyl methacrylate, cycloheptyl methacrylate, and cyclooctyl methacrylate. Among these, the alicyclic (meth)acrylic acid ester compound preferably includes a cycloalkyl group in which the number of carbon is 5 to 8, from the viewpoint of mechanical strength, environmental stability of the charge amount, and the like, and the cyclohexyl methacrylate is more preferably used.

As a monomer constituting the resin for coating, other monomers other than the alicyclic (meth)acrylic acid ester compounds may be used. Examples of other monomers may include: styrene compounds such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene; methacrylic acid ester compounds such as methyl methacrylate, ethyl methacrylate, n-butyl methacrylate, iso-propyl methacrylate, iso-butyl methacrylate, t-butyl methacrylate, n-octyl methacrylate, 2-ethylhexyl methacrylate, stearyl methacrylate, lauryl methacrylate, phenyl methacrylate, benzyl methacrylate, isobornyl methacrylate, diethylaminoethyl methacrylate, and dimethylaminoethyl methacrylate; acrylic acid ester compounds such as methyl acrylate, ethyl acrylate, iso-propyl acrylate, n-butyl acrylate, t-butyl acrylate, isobutyl acrylate, n-octyl acrylate, 2-ethylhexyl acrylate, stearyl acrylate, lauryl acrylate, phenyl acrylate, and benzyl acrylate; olefin compounds such as ethylene, propylene, and isobutylene; vinyl halide compounds such as vinyl chloride, vinylidene chloride, vinyl bromide, vinyl fluoride, and vinylidene fluoride; vinyl ester compounds such as vinyl propionate, vinyl acetate, and vinyl benzoate; vinyl ether compounds such as vinyl methyl ether and vinyl ethyl ether; vinyl ketone compounds such as vinyl methyl ketone, vinyl ethyl ketone, and vinyl hexyl ketone; N-vinyl compounds such as N-vinyl carbazole, N-vinyl indole, and N-vinyl pyrrolidone; vinyl compounds such as vinylnaphthalene and vinylpyridine; and acrylic acids or methacrylic acid derivatives such as acrylonitrile, methacrylonitrile, and acrylamide. These other monomers may be used singly or in combination of two or more kinds thereof.

Among these other monomers, the styrene and methyl methacrylate are preferably used from the viewpoint of mechanical strength, environmental stability of the charge amount, and the like.

The ratio between the constituent unit derived from the alicyclic (meth)acrylic acid ester compound in the resin for coating and the constituent unit derived from other monomers is preferably 10:90 to 100:0, and more preferably 30:70 to 70:30.

(Method of Producing Resin for Coating)

There are no particular limitations on a method for producing the resin for coating, and any conventionally known polymerization method can be appropriately used. Examples of the polymerization method include a pulverization method, an emulsion dispersion method, a suspension polymerization method, a solution polymerization method, a dispersion polymerization method, an emulsion polymerization method, an emulsion polymerization coagulation method, and other known methods. In particular, the synthesis is preferably achieved by the emulsion polymerization method from the viewpoint of control of the particle size.

There are also no particular limitations on condition for polymerization such as a polymerization initiator, a surfactant, and a chain transfer agent that is optionally used, in addition to the monomer that is used in such an emulsion polymerization method, and also on the polymerization conditions such as the polymerization temperature, and conventionally known conditions for polymerization such as a polymerization initiator, a surfactant and a chain transfer agent can be used. The polymerization conditions such as the polymerization temperature can also be adjusted appropriately using conventionally known polymerization conditions. Specifically, it is preferable to perform emulsion polymerization using the various additives described in Examples that will be described below. That is, it is preferable to perform emulsion polymerization of the monomer composition using sodium dodecyl sulfate as an anionic surfactant, water (ion-exchanged water) as a solvent, and potassium persulfate (KPS) as a polymerization initiator, respectively.

<<Weight-Average Molecular Weight of Resin for Coating>>

A weight average molecular weight of the resin for coating (polymer obtained by polymerizing the monomer) is not particularly limited as long as the effects of the present invention can be effectively realized. However, the weight average molecular weight is preferably in the range of 200,000 to 800,000, and more preferably 300,000 to 700,000. When the weight average molecular weight of the resin for coating is 200,000 or more, it is preferable from the viewpoint that the shrinkage of the resin-coated layer that is constituted of the resin for coating would not excessively accelerated and adhesion of the carrier particles would occur with difficulties on the surface of the core particles. When the weight average molecular weight of the resin for coating is 800,000 or less, a satisfactory amount of charge can be maintained for a long period without causing decrease in the amount of charge due to the migration of an external additive from the toner particles to the surface of the carrier particles.

The weight average molecular weight of the resin for coating is measured by gel permeation chromatography (GPC) and, more specifically, is measured according to the method described below.

An apparatus “HLC-8220GPC” (manufactured by Tosoh Corp.) and “TSK guard column Super HZ-L and TSK GEL SUPER HZM-M3 series” (manufactured by Tosoh Corp.) as columns are used, and while a column temperature is maintained at 40° C., tetrahydrofuran (THF) as a carrier solvent is allowed to flow at a flow rate of 0.35 ml/min. A measurement sample is dissolved in tetrahydrofuran so as to give a concentration of 1 mg/ml under a dissolving condition that treats the measurement sample using an ultrasonic dispersing machine for 5 minutes at room temperature. Subsequently, a sample solution is obtained by treating the solution with a membrane filter having a pore size of 0.2 μm. 10 μL of this sample solution is poured into the apparatus together with the carrier solvent, and detected using a refractive index detector (RI detector). The weight average molecular weight distribution of the measurement sample is calculated using a calibration curve measured using monodispersing polystyrene standard particles. Regarding the polystyrene for the measurement of the calibration curve, ten samples are used.

For the purpose of adjusting volume resistivity of the carrier particles, the resin-coated layer formed from the resin for coating may contain a conductive agent such as carbon black.

(Method of Producing Carrier Particles)

Specific production methods of forming the carrier particles according to the present invention obtained in such a manner that the surface of the core particles is coated with the resin for coating include a wet coating method and a dry coating method. The respective methods will be described in detail below.

<Wet Coating Method>

The wet coating method includes:

(1) Fluidized bed type spray coating method of spray-coating a surface of core particles with a coating liquid prepared by dissolving a resin for coating in a solvent, using a fluidized bed, subsequently drying the particles, and thereby producing carrier particles obtained in such a manner that the surface of the core particles is coated with the resin for coating;

(2) Immersion type coating method of core particles by immersing the core particles in a coating liquid prepared by dissolving the resin for coating in a solvent, subsequently drying the particles, and thereby producing carrier particles obtained in such a manner that the surface of the core particles is coated with the resin for coating;

(3) Polymerization method of coating core particles by immersing the core particles in a coating liquid prepared by dissolving a reactive compound for forming a resin for coating (including a polymerization initiator and the like, in addition to a monomer composition for synthesizing a resin for coating) in a solvent, subsequently performing a polymerization reaction by applying heat or the like, to form a resin-coated layer, and thereby producing carrier particles obtained in such a manner that the surface of the core particles is coated with the resin for coating.

<Dry Coating Method>

The dry coating method includes: for example, (1) a method of adhering a resin for coating on the surface of core particles to be coated, subsequently applying mechanical impact force and fixing the resin for coating adhered onto the surface of the core particles to be coated by melting or softening the resin for coating, and thereby producing carrier particles obtained in such a manner that the surface of the core particles is coated with the resin for coating.

Specifically, the dry coating method (1) described above may include a method (mode) of subjecting core particles and a resin for coating to high-speed stirring with a high-speed stirring mixer which can exert mechanical impact force under no heating or under heating, repeatedly exerting the impact force to the mixture, melting or softening the particles to fix the particles onto the surface of the core particles to form a resin-coated layer, and thereby producing carrier particles obtained in such a manner that the surface of the core particles is coated with the resin for coating. In the case of heating the particles, the temperature is preferably 60 to 130° C. The reason is that when the heating temperature is excessively high, coagulation between the carrier particles is likely to occur. That is, when the particles are heated at a temperature in the range described above, coagulation between the carrier particles does not occur, and the resin-coated layer in the form of a uniform layer can be formed by fixing the particles of the resin for coating onto the surface of the core particles.

Regarding a method of forming carrier particles obtained in such a manner that the surface of the core particles is coated with the resin for coating according to the present invention, the dry coating method is particularly preferred from the viewpoint of the fact that a solvent is not used, an environmental load is small, and the surface of the core particles can be uniformly coated with the resin for coating. This dry coating method includes at least the following processes.

Process 1: a process of mixing (mechanically stirring) a material prepared by blending appropriate amounts of the core particles, a resin for coating, and an additive (added as necessary) at room temperature (20 to 30° C.), and attaching the resin for coating and the optionally added additive to the surfaces of the individual core particles in the form of a uniforms layer;

Process 2: subsequently, a process of applying mechanical impact or heat to the particles to melt or soften the resin for coating adhered to the surface of the core particles, thereby fixing the resin for coating thereon, and thereby forming a resin-coated layer; and

Process 3: subsequently, a process of cooling the product to room temperature (20 to 30° C.).

Furthermore, if necessary, Processes 1 through 3 can be repeated several times, and a resin-coated layer having a desired thickness can be formed.

An amount of the resin for coating that is blended in the Process 1 is preferably from 1 to 7 parts by mass relative to 100 parts by mass of the core particles. When the amount of the particles of the resin for coating to be added is 1 part or greater relative to 100 parts by mass of the core particles, it is preferable from the viewpoint that the core particles can be completely coated with the resin for coating. Furthermore, when the amount of the particles of the resin for coating to be added is 7 parts or less relative to 100 parts by mass of the core particles, it is preferable from the viewpoint that the generation of coagulated particles can be suppressed and a uniform resin-coated layer can be formed on the core particles.

In regard to the Process 2, it is preferable to employ a process of applying mechanical impact force to the system while the core particles attached with the resin for coating are heated to a temperature equal to or higher than a glass transition temperature of the resin for coating, spreading and fixing the resin for coating over the surface of the core particles to coat the surface of the core particles, and thereby forming a resin-coated layer.

Examples of the apparatus to apply mechanical impact or heat in the Process 2 include a pulverizer having a rotor and a liner, such as a turbo mill, a pin mill or a Kryptron, and a high-speed stirring mixer equipped with a horizontal stirring blade. Among these, the high-speed stirring mixer equipped with the horizontal stirring blade is preferred since a resin-coated layer can be satisfactorily formed.

The time for applying mechanical impact or heat in the Process 2 may be varied with the apparatus, and the time is usually 10 to 100 minutes. When mechanical impact or heat is applied for a time period in the range described above, coagulation between the carrier particles does not occur, the resin for coating is uniformly fixed onto the surface of the core particles, and thus a resin-coated layer can be satisfactorily formed.

In the case of using the high-speed stirring mixer with a horizontal stirring blade, the peripheral speed is preferably 3 to 20 m/sec, and more preferably 4 to 15 m/sec. When the peripheral speed of the horizontal stirring blade is 3 m/sec or greater, the resin for coating can be satisfactorily fixed onto the surface of the core particles without causing blocking, to forma favorable resin-coated layer. Furthermore, when the peripheral speed of the horizontal stirring blade is 20 m/sec or less, the resin for coating can be fixed onto the surface of the core particles without causing destruction of the resin-coated layer, or destruction of the core particles themselves that constitute the carrier particles, to form a favorable resin-coated layer.

In the case of performing heating in the Process 2, the heating temperature is preferably in the range of temperatures higher by 5 to 20° C. than a glass transition temperature of a resin for coating, and specifically, the heating temperature is preferably in the range of 60 to 130° C. When the heating is carried out at a temperature in the range described above, coagulation between the carrier particles does not occur, and the resin for coating can be fixed onto the surface of the core particles, to form a resin-coated layer in the form of a uniform layer.

In the dry coating method, since an organic solvent and the like are not used, not only the resin-coated layer is dense and firm without any holes formed by solvent evaporation, but also carrier particles having a resin-coated layer with satisfactory adhesiveness to the core particles can be produced.

<Thickness of Resin-Coated Layer>

The thickness of the resin-coated layer is preferably 0.05 to 4 μm, and more preferably 0.2 to 3 μm. When the thickness of the resin-coated layer is within the range described above, the charging property and durability of the carrier particles can be improved.

The thickness of the resin-coated layer can be determined by the method described below.

A measurement sample is produced by cutting the carrier particles along a plane that passes through the center of the carrier particles with a focused ion beam apparatus, “SMI2050” (manufactured by Hitachi High-Tech Science Corporation), and a cross section of the measurement sample is observed with a transmission electron microscope “JEM-2010F” (manufactured by JEOL Ltd.), in a field of vision at a magnification of 5000 times. An average value of an area with the largest thickness and an area with the smallest thickness in that field of vision is designated as the thickness of the resin-coated layer. Meanwhile, measurements are taken at 50 sites, and if the number of measurements is insufficient in a single field of vision in a photograph, the number of fields of vision is increased until the number of measurements of 50 is fulfilled.

<Volume-Average Particle Size of Carrier Particles>

A volume-average particle size of carrier particles is 15 μm or more and 30 μm or less. When the volume-average particle size is less than 15 μm, fluidity of the carrier particles is reduced, and a property of mixing with toner particles is lowered, so that the rising of the charge amount is decreased. On the other hand, when the volume-average particle size exceeds 30 μm, a surface area of the carrier particles becomes smaller, the toner particles are not sufficiently charged. The volume-average particle size is preferably from 18 μm or more and 28 μm or less. The volume-average particle size of the carrier particles is intended to adopt a volume-based median diameter (D₅₀) as measured by the following method.

<<Measurement Method>>

The volume-based median diameter (D₅₀) of the carrier particles is a measured in a wet manner using a laser diffraction-type particle size distribution measuring apparatus “HEROS KA” (manufactured by Japan Laser Corp.). Specifically, first, an optical system having a focal position of 200 mm is selected, and a measurement time is set to five seconds. Then, the carrier particles for measurement are added to 0.2% dodecyl sodium sulfate aqueous solution and are dispersed therein for three minutes using an ultrasonic washing machine “US-1” (manufactured by AS ONE Corp.), whereby a sample dispersion liquid for measurement is produced. Several droplets of the sample dispersion liquid are supplied to the “HEROS KA” to start measurement at the time when a sample concentration gauge reaches a measurable region. With respect to a particle-size range (channel) of the obtained particle size distribution, cumulative distribution is created from a small size side. Then, the particle size corresponding to 50% of the cumulative distribution was defined as a volume-average particle size D₅₀.

The volume-average particle size of the carrier particles can be controlled by control of pulverization conditions, a diameter of beads to be used, a composition, a pulverization time, a classification method, and the like in the pulverizer.

<Volume Resistivity>

Volume resistivity of the carrier particles is 1×10⁸ Ω·cm or more and 1×10¹⁰ Ω·cm or less. When the volume resistivity is less than 1×10⁸ Ω·cm, the toner particles are not sufficiently charged. On the other hand, when the volume resistivity exceeds 1×10¹⁰ Ω·cm, the rising of the charge amount of the toner particles is decreased. The volume resistivity is preferably 5×10⁸ Ω·cm or more and 5×10⁹ Ω·cm or less. Specifically, the volume resistivity can be measured by the following method.

<<Measurement Method>>

The volume resistivity according to the present invention means resistance that is dynamically measured under developing conditions by a magnetic brush. Specifically, the magnetic brush is formed in such a manner that a photosensitive drum is replaced by an electrode drum made of aluminum having the same dimension as the photosensitive drum and the carrier particles are supplied onto a developing sleeve. This magnetic brush is rubbed with the electrode drum made of aluminum, a voltage (500 V) is applied between the developing sleeve and the drum, thereby measuring a current flowing between the developing sleeve and the drum. Thus, the volume resistivity of the carrier particles can be obtained by the following Formula (2).

[Formula 2]

DVR (Ω·cm)=(V/I)×(N×L/Dsd) (2)

DVR: Volume resistivity (Ω·cm)

V: Voltage between developing sleeve and drum (V)

I: Measured current value (A)

N: Width of developing nip (cm)

L: Length of developing sleeve (cm)

Dsd: Distance between developing sleeve and drum (cm)

In the present invention, the measurement are performed with V=500 V, N=1 cm, L=6 cm, and Dsd=0.6 mm.

The volume resistivity of the carrier particles can be controlled by control of the amount of resin for coating to be added (thickness of a resin-coated layer), a shape of the carrier particles, the amount of conductive agent to be added to the resin-coated layer, and the like.

<True Specific Gravity>

A true specific gravity of the carrier particles is 4.25 g/cm³ or more and 5 g/cm³ or less. When the true specific gravity is less than 4.25 g/cm³, since collision energy of the carrier particles with respect to the toner particles becomes smaller, the rising of the charge amount of toner particles is decreased. On the other hand, when the true specific gravity exceeds 5 g/cm³, the deterioration of the toner particles becomes remarkable by the collision of the carrier particles with the toner particles. The true specific gravity of the carrier particles is preferably 4.4 g/cm³ or more and 4.8 g/cm³ or less. The true specific gravity can be measured by a true density measuring machine (VOLUMETER. VM-100 type manufactured by S-TEC Co., Ltd.). As described above, the true specific gravity of the carrier particles can be controlled by control the kind of raw material to be used for the core particles, the ratio of the raw material to be added, the thickness of the resin-coated layer, or the like.

<Shape Factor SF-1>

A shape factor SF-1 is an index representing sphericity. In a case of a perfect sphere, the shape factor SF-1 is 100.

In the present invention, the shape factor SF-1 of the carrier particles is 105 or more and 125 or less. When the shape factor is less than 105, frictional force between the carrier particles and the toner particles is insufficient because of being closer to the perfect sphere, and the rising of the charge amount of toner particles is decreased. On the other hand, when the shape factor exceeds 125, fluidity of the carrier particles is reduced, and the rising of the charge amount of toner particles is decreased. The shape factor SF-1 is preferably 110 or more and 120 or less.

The shape factor SF-1 is a numerical value calculated by the following Formula (3).

[Formula 3]

SF-1=[{(Maximum length of particle)²/(Projection area of particle)}×(π/4)]×100 (3)

In the measurement of SF-1 of the carrier particles, the carrier particles are prepared, and a process of pre-preparation is performed when a sample is not a single carrier particle substance but a developer.

<<Pre-Preparation>>

A developer, a small amount of neutral detergent, and pure water are added into a beaker and blended in the beaker, and a supernatant solution is thrown away while putting a magnet on the bottom of the beaker. Further, the toner particles and the neutral detergent are removed to separate out only carrier by throwing the supernatant solution away after further adding pure water. The resulting is dried at 40° C. to obtain carrier particles as a single body.

<<Measurement Method>>

(Measurement)

By the scanning type electron microscope, 100 or more carrier particles are randomly photographed at 150 times, and the photographed images are received by a scanner. The received images are analyzed using an image processing analyzer “LUZEX AP” (manufactured by NIRECO Corporation), and the maximum length and a projected area are determined for each of the carrier particles, whereby the shape factor SF-1 is calculated using Formula (3) described above. An average value of the shape factor SF-1 calculated for each of the particles is referred to a “shape factor SF-1” in the present invention.

The shape factor SF-1 of the carrier particles can be controlled by control of the kind of raw material used for the core particles, the ratio of the raw material to be added, the calcination temperature at the time of producing the core particles, and the like.

[Toner Particles]

The two-component developer according to the present invention contains toner particles obtained in such a manner that an external additive is attached to toner base particles.

(Toner Base Particles)

Specifically, the toner base particles according to the present invention contain at least a binder resin (hereinafter, also referred to as a “toner resin”) and colorant as necessary. In addition, the toner base particles may further contain other components such as a releasing agent and a charge controlling agent as necessary.

(Binder Resin)

A thermoplastic resin is preferably used for the binder resin that forms the toner base particles.

Such a binder resin is not particularly limited, and any binder resin which is generally used as a binder resin to form a toner can be used. Specifically, examples of the binder resin include styrene resins, acrylic resins, styrene-acrylic copolymer resins, polyester resins, silicone resins, olefin resins, amide resins, and epoxy resins.

Among them, the styrene resins, the acrylic resins, the styrene-acrylic copolymer resins, and the polyester resins are preferable in terms of having high sharp melting characteristics at low viscosity. These resins may be used singly or in combination of two or more kinds thereof. In particular, at least a crystalline polyester resin is preferably contained from the viewpoint of making the toner particles soluble with ease and achieving energy saving at the time of fixing. In this description, the term “crystalline” means a structure that does not have a stepwise endothermic change in differential scanning calorimetry (DSC) but has a clear endothermic peak. At this time, specifically, the clear endothermic peak means a peak in which, when a measurement is made at a temperature increase rate of 10° C./min in differential scanning calorimetry (DSC), the half-value width of an endothermic peak falls within a range of 15° C. or lower.

The crystalline polyester resin is synthesized from a polycarboxylic acid component and a polyhydric alcohol component.

Examples of the polyvalent carboxylic acid component include: for example, aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, dodecanedioic acid (1,12-dodecanedicarboxylic acid), 1,14-tetradecanedicarboxylic acid, 1,18-octadecanedicarboxylic acid; aromatic dicarboxylic acids such as phthalic acid, isophthalic acid, terephthalic acid, naphthalene-2,6-dicarboxylic acid, malonic acid, and dibasic acids such as mesaconic acid; and the like, furthermore, anhydrides thereof or lower alkyl esters thereof, but this invention is not limited thereto. These may be used singly or may be used in combination of two or more.

Examples of trivalent or higher carboxylic acids include: for example, 1,2,4-benzenetricarboxylic acid, 1,2,5-benzenetricarboxylic acid, 1,2,4-naphthalene tricarboxylic acid, and the like, and anhydrides thereof or lower alkyl esters thereof. These may be used singly or may be used in combination of two or more. Furthermore, in addition to the polycarboxylic acid component, dicarboxylic acid component having a double bond may be used. The dicarboxylic acid having a double bond includes: for example, maleic acid, fumaric acid, 3-hexenedioic acid, 3-octenedioic acid and the like, but this invention is not limited thereto. Furthermore, lower esters thereof and acid anhydrides thereof, and the like may be included.

On the other hand, as the polyhydric alcohol component, aliphatic diols are preferable, and a straight-chain aliphatic diol, in which the number of carbon atoms of the main chain is 7 to 20, is more preferable. When the aliphatic diol is a linear type, crystalline of polyester resin is maintained, and since the drop in melting temperature is suppressed, toner blocking resistance, image storability, and low-temperature fixability are excellent. Further, when the number of carbon atoms is 7 to 20, melting point at the time of polycondensation with a polycarboxylic acid component is suppressed low, the low-temperature fixing can be achieved, and in practice, it can be easy to obtain the material. It is more preferable that the number of carbon atoms in the main chain portion is 7 to 14.

The aliphatic diol preferably used for the synthesis of the crystalline polyester resin specifically includes: for example, ethylene glycol, 1,3-propanediol, 1,4-butanediol, 1,5-pentanediol, 1,6-hexanediol, 1,7-heptane diol, 1,8-octane diol, 1,9-nonane diol, 1,10-decanediol, 1,11-undecanediol, 1,12-dodecane diol, 1,13-tri-decanediol, 1,14-tetradecane diol, 1,18-octadecanediol and the like, but not limited thereto. These may be used singly or may be used in combination of two or more. Considering easy availability, 1,8-octanediol, 1,9-nonane diol, 1,10-decanediol are preferable among them. Examples of trivalent or more alcohols include: glycerin, trimethylolethane, trimethylolpropane, pentaerythritol and the like. These may be used singly or may be used in combination of two or more.

The crystalline polyester resin, according to a conventional method, may be synthesized by carrying out polycondensation reaction of a polycarboxylic acid component and a polyhydric alcohol component, under the presence of a polymerization catalyst such as dibutyltin oxide or tetra butoxy titanate.

The reaction temperature in the polycondensation reaction is preferably carried out at 180° C. to 230° C. The pressure inside the reaction system is reduced, if necessary, and the reaction is performed while removing water or alcohol generated by the polycondensation. When the monomer is not dissolved or compatibilized under a reaction temperature, the monomer may be dissolved adding a solvent having a high boiling point as a dissolution aid. The polycondensation reaction is performed while distilling off the dissolution aid. When the monomer having poor compatibility is present in copolymerization reaction, the monomer with poor compatibility and acid or alcohol to be poly-condensed with the monomer are condensed in advance, and then poly-condensation may be performed together with the main component.

The weight-average molecular weight of the crystalline polyester resin is preferably 5,000 to 50,000 from the viewpoint of a good low temperature fixing property and image storage stability. In the present specification, the weight-average molecular weight of the crystalline polyester resin is a value measured by GPC, and can be measured under the same measurement conditions as those for the resin for coating.

As a polymerizable monomer for obtaining the binder resin other than the crystalline polyester resin (hereinafter, also referred to as “other resins”), for example, styrene monomers such as styrene, methyl styrene, methoxy styrene, butyl styrene, phenyl styrene, and chlorostyrenes; acrylic acid ester monomers such as methyl acrylate, ethyl acrylate, n-butyl acrylate, 2-ethylhexyl acrylate, and n-stearyl acrylate; methacrylic acid ester monomers such as methyl methacrylate, ethyl methacrylate, n-butyl methacrylate, and 2-ethylhexyl methacrylate; carboxylic acid monomers such as acrylic acid, methacrylic acid, and fumaric acid may be used. These polymerizable monomers may be used singly or in even a combination of two or more.

These other resins can be produced by a known method such as a suspension polymerization method, an emulsion polymerization method, and a dispersion polymerization method. Among them, from the viewpoint of control of particle size, the emulsion polymerization method is preferable.

When manufacturing other resins by the emulsion polymerization method, as the radical polymerization initiator to be used, for example, persulfates such as ammonium persulfate, potassium persulfate and the like, water-soluble azo compounds such as 4,4′-azobis (4-cyano valeric acid), 2,2′-azobis (2-amidinopropane) hydrochloride, and the like, and hydrogen peroxide may be used. These radical polymerization initiators can also be used as a redox polymerization initiator, as desired. For example, a combination of persulfate and sodium metabisulfite, sodium sulfite, hydrogen peroxide and ascorbic acid may be used. As the chain transfer agent to be used, thiol compounds such as n-dodecyl mercaptan, tert-dodecyl mercaptan, n-octyl mercaptan, and halogenated methane such as tetrabromomethane and tribromochloromethane may be used.

The weight-average molecular weight of other resins is preferably 10,000 to 50,000 from the viewpoint of low-temperature fixability and image storability. The weight-average molecular weight of the other resins is a value measured by GPC, and can be measured under the same measurement conditions as those for the resin for coating.

[External Additive]

On the surface of the toner base particles according to the present invention, the external additive is adhered for the purpose of controlling the fluidity and charging properties. As the external additive, a known metal oxide particles can be used, for example, silica particles, titania particles, alumina particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles, and the like may be used. These may be used singly or in combination of two or more.

Particularly with respect to the silica particles, it is more preferable to use silica particles made by a sol-gel method. Since silica particles prepared by the sol-gel method has a feature that a particle size distribution is narrow, it is preferably used to suppress the variation in adhesion strength. The number average primary particle diameter of the silica particles formed by sol-gel method, is preferably in the range of 70 to 150 nm. Silica particles having a number-average primary particle diameter within this range has a large particle size in comparison with other external additives and has a role as a spacer, and therefore has an effect that other external additives of a small particle size are stirred and mixed in an developing machine, thereby preventing from being buried in toner base particles and preventing toner base particles from being fused with each other.

The number average primary particle diameter of the metal oxide particles other than silica particles made by the sol-gel method, is preferably 10 to 70 nm, and more preferably 10 to 40 nm. The number average primary particle diameter of the metal oxide particles, for example, can be measured by a method for determining the number average primary particle diameter by the image processing of an image taken with a transmission electron microscope.

In addition, organic fine particles of a homopolymer such as styrene, methyl methacrylate, and the like or copolymers thereof may be used as an external additive.

Metal oxide particles used as an external additive of the present invention are preferably subjected to hydrophobic treatment of the surface by using a known surface treatment agent such as a coupling agent. Examples of the surface treatment agent preferably include: dimethyldimethoxysilane, hexamethyldisilazane (HMDS), methyltrimethoxysilane, isobutyltrimethoxysilane, decyl trimethoxy silane.

In addition, as the surface treatment agent, it is also possible to use silicone oil. Specific examples of the silicone oil include: for example, cyclic compounds such as organosiloxane oligomer, octamethylcyclotetrasiloxane or decamethylcyclopentasiloxane, tetramethylcyclotetrasiloxane, tetravinyltetramethylcyclotetrasiloxane and the like, or a straight-chain or branched organosiloxane. Further, silicone oil, the reactivity of which is high by introducing a modifying group into side chains, one end, both ends, a side chain terminal, side chain terminals, and the like, and at least ends of which are modified, may be used. Examples of modified groups include: an alkoxy group, a carboxyl group, a carbinol group, higher fatty acid-modified, a phenol group, an epoxy group, a methacrylic group, an amino group, and the like, but it is not intended to be particularly limited. Further, for example, silicone oil having several types of modifying groups such as an amino/alkoxy-modified group may be used.

Furthermore, the mixed treatment or the combined treatment may be performed by using dimethyl silicone oil and the modified silicone oil, and the other surface treatment agents. The treatment agent to be combined includes: for example, a silane coupling agent, a titanate coupling agent, an aluminate-based coupling agent, various silicone oils, fatty acids, fatty acid metal salts, an ester compound thereof, and rosin acids.

Hydrophobicity of the metal oxide particles is preferably about 40 to 80%. It is noted that the hydrophobicity of the metal oxide particles is represented by a measure of the wettability to methanol, and is defined by the following Formula (4).

[Formula 4]

Hydrophobicity (%)=(a/(a+50))×100 (4)

A method of measuring the hydrophobicity is as follows. The particles to be measured are weighed by 0.2 g and are added to distilled water of 50 ml which is placed in a beaker having an inner volume of 200 ml. The burette tip is immersed in the liquid of methanol, and the whole of the particles is slowly added dropwise from the burette until wet with slowly being stirred. When the amount of methanol needed to wet the particles completely is set to a (ml), hydrophobicity is calculated by the Formula (3).

<Lubricant>

Lubricants can be also used as an external additive to improve cleaning ability or transferability. Examples of the lubricants include higher fatty acid metal salts such as stearates of zinc, aluminum, copper, magnesium, calcium and the like; oleates of zinc, manganese, iron, copper, magnesium and the like; palmitates of zinc, copper, magnesium, calcium and the like; linolates of zinc, calcium and the like; and ricinolates of zinc, calcium and the like.

The amount of such external additives to be added is preferably from 0.1 to 10 mass % and more preferably from 1 to 5 mass % with respect to the total of toner particles.

[Internal Additive]

<Releasing Agent>

The toner particles may contain a releasing agent. Here, the releasing agent is not particularly limited and may include: for example, hydrocarbon-based wax such as polyethylene wax, oxidized polyethylene wax, polypropylene wax, and oxidized polypropylene wax; carnauba wax; fatty acid ester wax; Sasolwax; rice wax; candelilla wax; jojoba oil wax; and beeswax which are already known.

The amount of releasing agent contained in the toner particles is preferably from 1 to 30 parts by mass and more preferably from 5 to 20 parts by mass with respect to 100 parts by mass of a binder resin.

<Charge Controlling Agent>

The toner particles may contain a charge controlling agent. For example, the charge controlling agent may include a zinc- or aluminum-metal complex of a salicylic acid derivative (salicylic acid metal complex), calixarene-based compound, organic boron compound, and fluorine-containing quaternary ammonium salt compound.

The content of the charge controlling agent in the toner particles is preferably from 0.1 to 5 parts by mass relative to 100 parts by mass of the binder resin.

<Colorant>

The toner particles according to the present invention may further contain a colorant for a color toner.

Known inorganic or organic colorants may be used as the colorant. Specific colorants are represented below.

As a black colorant, for example, carbon blacks such as furnace black, channel black, acetylene black, thermal black, and lampblack, or a magnetic powder of magnetite or ferrite may be used.

Examples of colorants for magenta or red may include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 60, C. I. Pigment Red 63, C. I. Pigment Red 64, C. I. Pigment Red 68, C. Pigment Red 81, C. I. Pigment Red 83, C. I. Pigment Red 87, C. I. Pigment Red 88, C. I. Pigment Red 89, C. I. Pigment Red 90, C. I. Pigment Red 112, C. I. Pigment Red 114, C. I. Pigment Red 122, C. I. Pigment Red 123, C. I. Pigment Red 139, C. I. Pigment Red 144, C. I. Pigment Red 149, C. I. Pigment Red 150, C. I. Pigment Red 163, C. I. Pigment Red 166, C. I. Pigment Red 170, C. I. Pigment Red 177, C. I. Pigment Red 178, C. I. Pigment Red 184, C. I. Pigment Red 202, C. I. Pigment Red 206, C. I. Pigment Red 207, C. I. Pigment Red 209, C. I. Pigment Red 222, C. I. Pigment Red 238, and C. I. Pigment Red 269.

Examples of colorants for orange or yellow include C. I. Pigment Orange 31, C. I. Pigment Orange 43, C. I. Pigment Yellow 12, C. I. Pigment Yellow 14, C. I. Pigment Yellow 15, C. I. Pigment Yellow 17, C. I. Pigment Yellow 74, C. I. Pigment Yellow 83, C. I. Pigment Yellow 93, C. I. Pigment Yellow 94, C. I. Pigment Yellow 138, C. I. Pigment Yellow 155, C. I. Pigment Yellow 162, C. I. Pigment Yellow 180, and C. I. Pigment Yellow 185.

Further, examples of colorants for green or cyan may include C. I. Pigment Blue 2, C. I. Pigment Blue 3, C. I. Pigment Blue 15, C. I. Pigment Blue 15:2, C. I. Pigment Blue 15:3, C. I. Pigment Blue 15:4, C. I. Pigment Blue 16, C. I. Pigment Blue 17, C. I. Pigment Blue 60, C. I. Pigment Blue 62, C. I. Pigment Blue 66, and C. I. Pigment Green 7.

In addition, examples of dyes may include C. I. Solvent Red 1, C. I. Solvent Red 49, C. I. Solvent Red 52, C. I. Solvent Red 58, C. I. Solvent Red 63, C. I. Solvent Red 111, C. I. Solvent Red 122, C. I. Solvent Yellow 2, C. I. Solvent Yellow 6, C. I. Solvent Yellow 14, C. I. Solvent Yellow 15, C. I. Solvent Yellow 16, C. I. Solvent Yellow 19, C. I. Solvent Yellow 21, C. I. Solvent Yellow 33, C. I. Solvent Yellow 44, C. I. Solvent Yellow 56, C. I. Solvent Yellow 61, C. I. Solvent Yellow 77, C. I. Solvent Yellow 79, C. I. Solvent Yellow 80, C. Solvent Yellow 81, C. I. Solvent Yellow 82, C. I. Solvent Yellow 93, C. I. Solvent Yellow 98, C. I. Solvent Yellow 103, C. I. Solvent Yellow 104, C. I. Solvent Yellow 112, C. I. Solvent Yellow 162, C. I. Solvent Blue 25, C. I. Solvent Blue 36, C. I. Solvent Blue 60, C. I. Solvent Blue 70, C. I. Solvent Blue 93, and C. I. Solvent Blue 95.

These colorants may be used singly or in combination of two or kinds thereof if necessary. When the colorant is used, the amount of colorant to be added is preferably from 1 to 30 mass %, and more preferably from 2 to 20 mass % with respect to the total toner.

The colorant to be used may be subjected to a surface-modifying treatment. Commonly known surface modifiers can be used, and specifically, a silane coupling agent, a titanium coupling agent, an aluminum coupling agent or the like can be preferably used.

[Method of Producing Toner Particles]

The toner particles according to the present invention are produced in such a manner that the above-described external additive is added to toner base particles containing the binder resin and, if necessary, the internal additive such as the releasing agent or the colorant.

(Method of Producing Toner Base Particles)

The toner base particles according to the present invention, that is, particles at a stage before the addition of the external additive can be produced by toner producing methods which are known. That is, the toner producing methods may include a so-called pulverization method which produces the toner base particles through processes of mixing, pulverizing, and classifying, and a so-called polymerization method which polymerizes a polymerizable monomer and simultaneously forms particles while controlling shape and size.

Of these toner producing methods, the toner producing method according to the polymerization method can form the particles while controlling the shape or the size, and thus is advantageous in terms of the production of a small particle size of toner used to form a high quality image such as a fine dot image or a thin line image. The toner producing method according to the polymerization method is to produce the toner base particles through a step of forming resin particles by a polymerization reaction such as a suspension polymerization or an emulsion polymerization. Of the polymerization methods, the toner producing method according to the polymerization method having an association step is particularly preferred in which, for example, resin fine particles of about 100 nm are prepared by the polymerization reaction and then this resin fine particles are coagulated/fused to produce the toner base particles. When this association step is provided, for example, resin fine particles having a relatively low glass transition temperature contributing to low temperature fixing are coagulated, thereby producing core particles, and then resin particles having a relatively high glass transition temperature are allowed to adhere and coagulate to the surface of the core particles, whereby a core-shell toner can be produced.

In an emulsion association method, first, binder resin particles of around 100 nm are previously formed by a polymerization method or a suspension polymerization method, and toner particles are formed by coagulation and fusion of the resin particles. More specifically, a monomer constituting the binder resin is put and dispersed into a water-based medium, and such a polymerizable monomer is polymerized by a polymerization initiator, whereby the binder resin particles (dispersion liquid) are produced. In addition, when the colorant is contained, the colorant is separately dispersed in the water-based medium, whereby a colorant particles-dispersed liquid is produced. The fine colorant particles in the dispersion liquid preferably have a volume-based median diameter (D₅₀) of 80 to 200 nm. The volume-based median diameter of the fine colorant particles in the dispersion liquid can be measured using a microtrack particle size distribution measuring apparatus UPA-150 manufactured by Nikkiso Co., Ltd., for example.

Then, the above-described resin particles and, if necessary, the colorant particles are coagulated in the water-based medium and these particles are fused at the same time, whereby the toner base particles are produced. That is, after a coagulant such as an alkaline metal salt or a Group II element salt is added into the water-based medium in which the resin particles-dispersed liquid and the colorant particles-dispersed liquid are mixed, the resultant is heated at a temperature higher than the glass transition temperature of the resin particles, whereby the coagulation proceeds and the resin particles are fused together at the same time. Then, when the size of the toner base particles reaches a target size, the coagulation is stopped by the addition of salts. Thereafter, the toner base particles are subjected to aging until the shape thereof becomes a desired shape by heating a reaction system, whereby the toner base particles are completed.

During the coagulation, it is preferred to shorten the standing time of dispersion liquid after addition of a coagulant (an interval until start of heating) as much as possible. Namely, after adding a coagulant, it is preferred to start heating the dispersion liquid to be subjected to coagulation as promptly as possible and heat it to a temperature higher than the glass transition temperature of the binder resin. The standing time is usually within 30 minutes and preferably not more than 10 minutes. The temperature at which the coagulant is added is not particularly limited, but is preferably not higher than the glass transition temperature of the binder resin. Thereafter, it is preferred to raise the temperature by heating as promptly as possible and the temperature rise rate is preferably not less than 0.5° C./min. The upper limit of the temperature rise rate is not specifically limited but a rate of not more than 15° C./min is preferable in terms of inhibition of generation of coarse particles due to a rapid progress of coagulation. Moreover, after the dispersion liquid for coagulation reaches the temperature higher than the glass transition temperature, and the temperature of the dispersion liquid is maintained for a predetermined period of time to continue the fusion. Thus, the growth of the toner base particles (coagulation of binder resin particles and colorant particles) and the fusion (elimination of an interface between particles) can effectively proceed.

More particularly, it is preferable that a base such as aqueous sodium hydroxide is added to the dispersion liquid of the colorant particles and the binder resin particles in advance so as to impart coagulation property and the pH is adjusted to be 9 to 12. Subsequently, a coagulant such as aqueous magnesium chloride is added to the dispersion liquid containing the colorant particles and the binder resin particles while being stirred over a period of 5 to 15 minutes at 25 to 35° C. The amount of coagulant to be used is suitably 5 to 20 mass % with respect to the total amount of solid content of the binder resin particles and the colorant particles. Then, the mixture is left standing for a period of 1 to 6 minutes and the temperature thereof rises up to a temperature of 70 to 95° C. over a period of 30 to 90 minutes, whereby the coagulated resin particles and colorant particles can be fused. At this time, the volume-based median diameter of the fused toner base particles is measured. When the volume-based median diameter is 3 to 5 μm, the sodium chloride aqueous solution or the like is added to stop the growth of the particles. In addition, heating and stirring are performed at a liquid temperature of 80 to 100° C. in an aging process, whereby the fusion between the particles can also proceed until the average degree of circularity becomes 0.900 to 0.980.

<Coagulant>

A coagulant which can be used in the present invention is not particularly limited, but a coagulant selected from metal salts is suitably used. For example, a monovalent metal salt such as an alkali metal salt including sodium, potassium, and lithium; a divalent metal salt such as calcium, magnesium, manganese, or copper; and a trivalent metal salt such as iron or aluminum are exemplified. Sodium chloride, potassium chloride, lithium chloride, calcium chloride, magnesium chloride, zinc chloride, copper sulfate, magnesium sulfate, manganese sulfate, and the like are exemplified as specific salts, and the divalent metal salt is particularly preferred from these salts. When the divalent metal salt is used, the coagulation can proceed with a smaller amount. These salts may be used singly or in combination of two or more.

<Other Additives>

The dispersion liquid in the coagulation step may contain additives such as the above-described releasing agent and charge controlling agent, a dispersion stabilizer, and a surfactant which are known. These additives may be put in the coagulation step as a dispersion liquid of additive, or may be contained in the colorant particles-dispersed liquid or the binder resin-dispersed liquid.

The toner base particles which have grown to the desired size in the manner described above are filtered and dried. A filtering treatment method includes, for example, a centrifugal separation method, a reduced pressure filtration method using a Nutsche funnel or the like, and a filtration method using a filter press or the like, and is not particularly limited. Then, the filtered toner base particles (aggregation in a cake form) are washed with ion exchanged water, and thus extraneous matters such as the surfactant and the coagulant are removed. A washing treatment is performed such that washing is conducted with water until electrical conductivity of a filtrate reaches a level of 3 to 10 μS/cm, for example.

The drying may not be particularly limited as long as the toner base particles which have been washed can be dried. The dryer used in this step includes known dryers such as a spray dryer, a vacuum freeze dryer, and a reduced pressure dryer. A stationary tray dryer, a transportable tray dryer, a fluid layer dryer, a rotary type dryer, a stirring type dryer, or a flash dryer is preferably used. The amount of moisture contained in the dried toner base particles is preferably at most 5 mass %, more preferably at most 2 mass %.

In addition, when coagulation occurs among the dried toner base particles via weak interparticle attractive force, the coagulated body may be disintegrated. Herein, as the disintegrating apparatus, a mechanical pulverizing apparatus such as a jet mill, a Henschel mixer, a coffee mill, or a food processor may be used.

By a dry method of mixing the resulting dried toner base particles with the external additive which is added in a powdery, the external additive is added, whereby the toner particles according to the present invention are produced. As a mixer of the external additive, known various mixers such as a tubular mixer, a Henschel mixer, a Nautamixer, and a V-type mixer may be used. For example, in the case of using the Henschel mixer, a peripheral speed at a tip of a stirring blade is preferably set to be 30 to 80 m/s, and the stirring and mixing is performed for about 10 to 30 minutes at 20 to 50° C.

<Volume-Average Particle Size of Toner Particles>

The volume-average particle size of the toner particles according to the present invention is 3 μm or more and 5 μm or less. When the volume-average particle size is less than 3 μm, fluidity of the toner particles decreases and the rising of the charge amount of the toner particles is deteriorated. On the other hand, when the volume-average particle size exceeds 5 μm, image quality decreases. The volume-average particle size of the toner particles is preferably 3.5 μm or more and 4.5 μm or less.

Specifically, the volume-average particle size of the toner particles is intended to employ the volume-based median diameter (D₅₀) measured by the following method.

<<Measurement Method>>

The volume-based median diameter (D₅₀) of the toner particles can be measured and calculated using an apparatus configured in such a manner that a computer system for data processing is connected to “Coulter Multisizer 3 (manufactured by Beckmann Coulter Co.)”. The measurement procedure is practically as follows: 0.02 g of toner particles are added to 20 ml of a surfactant solution (for example, a surfactant solution obtained by diluting a neutral detergent containing a surfactant component with pure water by 10 times for the purpose of dispersing the toner particles) and are then subjected to ultrasonic dispersion for one minute, whereby a toner particles-dispersed liquid is produced. Using a pipette, the toner dispersion liquid is poured into a beaker having ISOTON II (manufactured by Beckman•Coulter Co.) within a sample stand, until a measurement concentration reaches 5 to 10%. The count number of the measurement machine is set to 25,000 to perform measurement. Then, an aperture diameter of the Multisizer 3 is set to 100 μm. The measurement range from 1 to 30 μm is divided into 256 sections to calculate the frequency number. A particle size corresponding to 50% of the volume-integrated fraction from the larger particles is defined as a volume-based median diameter (D₅₀).

The volume-average particle size of the toner particles can be controlled by control of a concentration of the coagulant and the amount of organic solvent to be added or a fusion time in the production method described above.

[Average Degree of Circularity of Toner Particles]

An average degree of circularity of the toner particles according to the present invention is preferably 0.98 or less, more preferably 0.97 or less, and still more preferably in the range of 0.93 to 0.97. When the average degree of circularity is within such a range, the toner particles are more easily charged.

The average degree of circularity can be measured using, for example, a flow-type particle image analyzer “FPIA-3000” (manufactured by Sysmex Corporation), and can be measured by the following method in particular.

<<Measurement Method>>

After the toner particles are wet into an aqueous surfactant solution and are subjected to ultrasonic dispersion for one minute, the average degree of circularity of the toner particles can be measured using “FPIA-3000” at an optimum concentration of the HPF detection number of 3,000 to 10,000 under a measurement condition of HPF (high power flow) mode. With such a range, a reproducible measurement value is obtained. The degree of circularity is calculated according to the following Formula (5).

[Formula 5]

Degree of circularity=(Circumference length of circle having projected area equivalent to projected area of particle image)/(Circumference length of projected particle image) (5)

The average degree of circularity is an arithmetic average value obtained in such a manner that the degrees of circularity of particles are added together and are then divided by the number of total particles.

The average degree of circularity of the toner particles can be controlled by control of a temperature, a time or the like during the aging in the production method described above.

[Two-Component Developer]

A two-component developer according to the present invention consists of carrier particles and toner particles, and can be produced in such a manner that the carrier particles and the toner particles described above are mixed with each other using a mixer.

As the mixer, for example, a Henschel mixer, a Nautamixer, and a V-type mixer can be exemplified. The amount of toner particles to be mixed is preferably 1 to 10 mass % with respect to the total of two-component developer.

[Image Forming Method]

The two-component developer according to the present invention can be used in various known electrophotographic image forming methods, and can be used in a monochromatic image forming method or a full-color image forming method, for example. In the full-color image forming method, either of a four-cycle type image forming method or a tandem type image forming method can be used. The four-cycle type image forming method is configured by four kinds of color developing devices related to each colors of yellow, magenta, cyan, and black and one electrostatic latent image carrier (also referred to as an “electrophotographic photosensitive element” or simply “photosensitive element”), and the tandem type image forming method is configured such that an image forming unit having a color developing device related to each of the colors and an electrostatic latent image carrier is mounted according to each of the colors.

In the electrophotographic image forming methods, specifically, using the two-component developer of the present invention, for example, charging occurs on the electrostatic latent image carrier by a charging device (charging process), an image is exposed to form an electrostatic latent image which is electrostatically formed (exposing process), the electrostatic latent image is subjected to developing in the developing device by the charging of the toner particles with the carrier particles contained in the two-component developer of the present invention, thereby being visualized, and thus a toner image is obtained (developing process). Then, the toner image is transferred to a sheet (transferring process), and then the toner image transferred onto the sheet is fixed on the sheet by a fixing of a contact heating type or the like (fixing process), whereby a visible image is obtained.

### Examples

The effect of the present invention will be described with reference to the following Examples and Comparative Examples. However, the technical scope of the present invention is not limited to only the following Examples. A weight-average molecular weight (Mw) of a binder resin and a resin for coating was measured under the following measurement conditions.

(Measurement of Weight-Average Molecular Weight (Mw))

Used apparatus: HLC-8220 (manufactured by Tosoh Corporation)

Column: TSKguardcolumn/TSKgel SuperHZMM (3 channels) (manufactured by Tosoh Corporation)

Column temperature: 40° C.

Mobile phase: tetrahydrofuran

Flow rate: 0.2 ml/min

Injection amount: 10 μl

Detector: refractive index detector (IR detector)

[Production of Toner]

<Production of Toner Base Particles 1>

(Preparation of Fine Colorant Particles-Dispersed Liquid)

A solution was prepared in such a manner that sodium n-dodecylsulfate of 11.5 parts by mass was dissolved while being stirred in ion exchanged water of 160 parts by mass, and the solution was gradually added with copper phthalocyanine (C.I. Pigment Blue 15:3) of 24.5 parts by mass while being stirred. Subsequently, the resulting solution was subjected to a dispersion treatment using a stirrer “CLEARMIX (registered trademark) W MOTION CLM-0.8” (manufactured by M Technique Co., Ltd.), whereby a “fine colorant particles-dispersed liquid (A1)” was prepared in which the fine colorant particles had a volume-based median diameter of 126 nm.

(Production of Core Resin)

[Production of Crystalline Polyester Resin]

A three-neck flask was introduced with 300 g of 1, 9-Nonane diol, 250 g of dodecanedioic acid, and 0.014 mass % of a catalyst Ti(OBu)₄ with respect to the dodecanedioic acid, and then a pressure of air in a vessel was reduced by a pressure reduction operation. In addition, the mixture was recirculated by mechanical stirring at 180° C. for six hours under an inert atmosphere of a nitrogen gas. Then, an unreacted monomer component was removed by distillation under reduced pressure, followed by being gradually heated to 220° C. and being stirred for 12 hours. Subsequently, cooling is performed when the resultant becomes a viscous state, whereby a crystalline polyester resin [B1] was obtained. In the obtained crystalline polyester resin [B1], a weight-average molecular weight (Mw) was 19,500 and a melting point was 75° C.

[First-Stage Polymerization]

Into a reaction vessel of 5 L fitted with a stirrer, a temperature sensor, a cooling tube, and a nitrogen gas-introducing apparatus, 4 g of sodium polyoxyethylene (2) dodecyl ether sulfate and 3000 g of ion exchanged water were poured. Then, an inner temperature of the reaction vessel was raised to 80° C. while the mixture was stirred at a stirring speed of 230 rpm under a nitrogen flow. After the temperature rising, the mixture was added with a solution obtained by dissolving 10 g of potassium persulfate in 200 g of the ion exchanged water, a temperature of the obtained solution was set to 75° C. A monomer mixture solution composed of the following compounds was dropped thereonto over one hour:

styrene: 568 g,

n-butyl acrylate: 164 g, and

methacrylic acid: 68 g.

After the monomer mixture solution was dropped, this system was heated and stirred at 75° C. for two hours, and was thereby subjected to polymerization. In such a way, a dispersion liquid of resin particles [C1] was prepared.

[Second-Stage Polymerization]

Into a reaction vessel of 5 L fitted with a stirrer, a temperature sensor, a cooling tube, and a nitrogen gas-introducing apparatus, a solution in which 2 g of sodium polyoxyethylene (2) dodecyl ether sulfate was dissolved in 3000 g of ion exchanged water was poured. After the reaction vessel was heated to 80° C., 42 g (in terms of a solid content) of the dispersion liquid of the resin particles [C1], 70 g of paraffin wax “HNP-0190” (manufactured by Nippon Seiro Co., Ltd.), and 70 g of the crystalline polyester resin [B1] were poured into the reaction vessel. Further, a monomer mixture solution composed of the following compounds was added and dissolved at 80° C.:

styrene: 195 g

n-butyl acrylate: 91 g

methacrylic acid: 20 g, and

n-octyl mercaptan: 3 g.

Thereafter, the monomer mixture solution was mixed and dispersed for one hour using a mechanical disperser “CLEARMIX (registered trademark)” (manufactured by M Technique Co., Ltd.) having a circulation passage, whereby a dispersion liquid containing emulsion particles (oil droplets) was obtained.

Subsequently, an initiator solution in which 5 g of potassium persulfate was dissolved in 100 g of ion exchange water was added to this dispersion, and this system was heated and stirred at 80° C. for one hour, and was thereby subjected to polymerization. In such a way, a dispersion liquid of resin particles [C2] was prepared.

[Third-Stage Polymerization]

Into the dispersion liquid of the resin particles [C2] as obtained above, a solution in which 10 g of potassium persulfate was dissolved in 200 g of ion exchange water was added, and then, under a temperature condition of 80° C., a monomer mixture solution composed of the following compounds was dropped thereonto over one hour:

styrene: 298 g,

n-butyl acrylate: 137 g,

n-stearyl acrylate: 50 g,

methacrylic acid: 64 g, and

n-octyl mercaptan: 6 g.

After the monomer mixture solution was dropped, this system was heated and stirred for two hours, and was thereby subjected to polymerization, followed by cooling to 28° C. In such a way, a dispersion liquid of fine core resin particles [C3] was prepared.

(Preparation of Shell Resin)

Into a reaction vessel fitted with a stirrer, a temperature sensor, a cooling tube, and a nitrogen gas-introducing apparatus, a surfactant solution in which 2.0 g of sodium polyoxyethylene dodecyl ether sulfate was dissolved in 3000 g of ion exchanged water was poured. Then, an inner temperature of the reaction vessel was raised to 80° C. while the surfactant solution was stirred at a stirring speed of 230 rpm under a nitrogen flow.

Into this solution, an initiator solution in which 10 g of potassium persulfate was dissolved in 200 g of ion exchanged water was added, and then, a monomer mixture solution composed of the following compounds was dropped thereonto over three hours:

styrene: 564 g,

n-butyl acrylate: 140 g,

methacrylic acid: 96 g, and

n-octyl mercaptan: 12 g.

After the monomer mixture solution was dropped, this system was heated and stirred for one hour at 80° C., and was thereby subjected to polymerization. In such a way, a dispersion liquid of fine shell resin particles [D1] was obtained.

(Step of Aggregating/Fusing)

360 g of the dispersion liquid (in terms of solid content) of the fine core resin particles [C3], 1100 g of ion exchange water, and 50 g of the dispersion liquid of fine colorant particles [A1] were poured into a reaction vessel of 5 L fitted with a stirrer, a temperature sensor, a cooling tube, and a nitrogen gas-introducing apparatus, the liquid temperature was adjusted to be 30° C. and then the pH was adjusted to be 10 by addition of 5 N of aqueous sodium hydroxide. Then, an aqueous solution obtained by dissolving 60 g of magnesium chloride in 60 g of ion exchange water was added at 30° C. over 10 minutes while being stirred. The temperature was held for 3 minutes, then the temperature started to rise, the temperature of this system rose to 85° C. over 60 minutes and a particle growth reaction was continued while the temperature of 85° C. was being held. In this state, the size of associated particles was measured using “Coulter Multisizer 3” (manufactured by Beckman Coulter, Inc.), and, when the volume-average median diameter (D₅₀) reached 3.9 μm, the addition of an aqueous solution obtained by dissolving 40 g of sodium chloride in 160 g of ion exchange water was performed to stop the growth of the particles and furthermore heating and stirring were performed at a liquid temperature of 80° C. over one hour in an aging process to proceed fusion between the particles. Thus, core particles [1] were formed.

Then, 80 g of the shell resin particles [D1] (in terms of solid content) was added, stirring was continued at 80° C. over one hour and the shell resin particles [S1] were fused to the surface of the core particles [1], whereby a shell layer was formed. Here, an aqueous solution obtained by dissolving 150 g of sodium chloride in 600 g of ion exchange water was added, an aging treatment was performed at 80° C., and the temperature was cooled to 30° C. when an average degree of circularity was 0.965, whereby a dispersion liquid of the toner base particles 1 was obtained. The volume-average particle size (volume-based median diameter (D₅₀)) of the toner base particles 1 after the cooling was 4 μm, and the average degree of circularity thereof was 0.965.

(Steps of Washing/Drying)

The dispersion liquid of the toner base particles 1 generated in the step of aggregating and fusing was subjected to solid-liquid separation with a centrifugal separator, and a wet cake of toner base particles 1 was formed. This wet cake was washed with ion exchange water of 35° C. until the electrical conductivity of a filtrate reaches 5 μS/cm in the centrifugal separator, was then transferred to “Flash jet dryer” (manufactured by Seishin Enterprise Co., Ltd.), followed by being dried until the amount of moisture reaches 0.8 mass %. Thus, the “toner base particles 1” were obtained.

<Production of Toner Base Particles 2 and 3>

Toner base particles 2 and 3 were produced in the same manner as in the “production of the toner base particles 1” except for being cooled at the time when the average degrees of circularity became 0.970 (toner base particles 2) and 0.975 (toner base particles 3), respectively.

<Production of Toner Base Particles 4 to 7>

Toner base particles 4 to 7 were produced in the same manner as in the “production of the toner base particles 1” except that an aqueous solution, in which 40 g of sodium chloride was dissolved in 160 g of ion exchanged water, was added at the time when the volume-based median diameters were 2.8 μm (toner base particles 4), 4.9 μm (toner base particles 5), 5.8 μm (toner base particles 6), and 2.6 μm (toner base particles 7), respectively, to stop the growth of particles.

<Production of Toner Particles 1 to 7>

(Step of External Additive Treatment)

“Toner base particles 1 to 7” produced as described above,

Sol gel silica (HMDS treatment, having a hydrophobicity of 72% and a number-average primary particle size of 130 nm) (2.0 mass % with respect to the toner base particles),

Hydrophobic silica (HMDS treatment, having a hydrophobicity of 72% and a number-average primary particle size of 40 nm) (2.5 mass % with respect to the toner base particles), and

Hydrophobic titanium oxide (HMDS treatment, having a hydrophobicity of 55% and a number-average primary particle size of 20 nm) (0.5 mass % with respect to the toner base particles).

The above materials were poured into a Henschel mixer-type “FM20C/I” (manufactured by Nippon Coke &Engineering Co., Ltd.), and were stirred for 15 minutes under a condition that the number of revolution was set such that a peripheral speed of a tip of a blade was 40 m/s, whereby “toner particles 1 to 7” were produced.

In addition, an article temperature was set to be 40° C.±1° C. at external additive mixing. The inner temperature of the Henschel mixer was controlled in such a manner that cooling water flowed at a flow rate of 5 L/minute to the outside bath of the Henschel mixer when the temperature was 41° C. and the cooling water flowed at a flow rate of 1 L/minute when the temperature was 39° C.

A volume-average particle size and an average degree of circularity of the toner particles 1 to 7 are indicated in the following Table 1. A measurement method is as follows.

<Volume-Average Particle Size of Toner Particles>

The volume-based median diameter (D₅₀) of toner particles can be measured and calculated using an apparatus configured in such a manner that a computer system for data processing is connected to “Coulter Multisizer 3 (manufactured by Beckmann Coulter Co.)”. The measurement procedure is practically as follows: 0.02 g of toner particles are added to 20 ml of a surfactant solution (for example, a surfactant solution obtained by diluting a neutral detergent containing a surfactant component with pure water by 10 times for the purpose of dispersing the toner particles) and are then subjected to ultrasonic dispersion for one minute, whereby a toner particles-dispersed liquid is produced. Using a pipette, the toner dispersion liquid is poured into a beaker having ISOTON II (manufactured by Beckman•Coulter Co.) within a sample stand, until a measurement concentration reaches 5 to 10%. The count number of the measurement machine is set to 25,000 to perform measurement. Then, an aperture diameter of the Multisizer 3 is set to 100 μm. The measurement range from 1 to 30 μm is divided into 256 sections to calculate the frequency number. A particle size corresponding to 50% of the volume-integrated fraction from the larger particles is defined as a volume-based median diameter (D₅₀).

<Average Degree of Circularity of Toner Particles>

<<Measurement Method>>

After the toner particles are wet into an aqueous surfactant solution and are subjected to ultrasonic dispersion for one minute, the average degree of circularity of the toner particles can be measured using “FPIA-3000” (manufactured by Sysmex Co.) at an optimum concentration of the HPF detection number of 3,000 to 10,000 under a measurement condition of HPF (high power flow) mode. With such a range, a reproducible measurement value is obtained. The degree of circularity is calculated according to the following Formula (5).

[Formula 6]

Degree of circularity=(Circumference length of circle having projected area equivalent to projected area of particle image)/(Circumference length of projected particle image) (5)

The degree of circularity is an arithmetic average value obtained in such a manner that the degrees of circularity of individual particles are added together and are then divided by the number of total particles.

TABLE 1

| | Volume-average | Average degree of |
|---|---|---|
| | particle size (μm) | circularity |
| Toner particle 1 | 4 | 0.965 |
| Toner particle 2 | 4 | 0.97 |
| Toner particle 3 | 4 | 0.975 |
| Toner particle 4 | 3 | 0.96 |
| Toner particle 5 | 5 | 0.96 |
| Toner particle 6 | 6 | 0.96 |
| Toner particle 7 | 2.8 | 0.96 |

[Production of Carrier]

(Production of Core Particle 1)

Raw materials were weighed to obtain 35 mol % of MnO, 14.5 mol % of MgO, 50 mol % of Fe₂O₃, and 0.5 mol % of SrO. The weighed raw materials were mixed with water and pulverized in a wet medium mill for five hours, whereby slurry was obtained.

The obtained slurry was dried with a spray drier to obtain spherical particles. After the adjustment of the size of the particles, the particles were temporarily calcined for two hours at 950° C. The calcined particles were pulverized in the wet ball mill for one hour with stainless steel beads having a diameter of 0.3 cm, followed by being pulverized for four hours with zirconia beads having a diameter of 0.5 cm. 0.8 mass % of PVA with respect to the solid component was added as a binder. The slurry was then granulated and dried by a spray drier. The dried grains were held for 5 hours at 1300° C. in an electric furnace and were subjected to a main calcination.

Thereafter, the calcined particles were disintegrated and classified to adjust the particle size. Then, the classified particles were magnetically separated to remove the particles with a low-magnetic force, whereby a core particle 1 was produced. The volume-average particle size of the core particle 1 was 24.2 μm.

(Production of Core Particles 2 to 7 and 12 to 16)

Core particles 2 to 7 and 12 to 16 were produced in the same manner as in the production of the core particle 1 except that zirconia beads of 0.5 cm was used and a pulverization time, temperature and time of the main calcination, and adjustment of particle size during the classification were respectively changed as indicated in the following Table 2.

(Production of Porous Core Particle 8)

Porous core particle 8 was produced in the same manner as in the production of the core particle 1 except that zirconia beads of 0.5 cm was used and a pulverization time, temperature and time of the main calcination, and adjustment of particle size during the classification were respectively changed as indicated in the following Table 2.

(Production of Core Particle 9)

Core particle 9 was produced in the same manner as in the production of the core particle 1 except that mixing ratios of raw materials were as follows: 15 mol % of MnO, 24.5 mol % of MgO, 10 mol % of SiO₂, 50 mol of Fe₂O₃, and 0.5 mol % of SrO.

(Production of Core Particle 10)

Core particle 10 was produced in the same manner as in the production of the core particle 1 except that mixing ratios of raw materials were as follows: 49.5 mol % of MnO, 50 mol of Fe₂O₃, and 0.5 mol % of SrO.

(Production of Core Particle 11)

200 parts by mass of phenol, 260 parts by mass of 37 mass % of formalin, 1600 parts by mass of spherical magnetite having a volume-average particle size of 0.3 μm, 31.2 parts by mass of 28 mass % of ammonia water, 4 parts by mass of calcium fluoride, and 200 parts by mass of water were introduced into the reaction apparatus while being stirred, and the temperature of the reaction apparatus rose to 85° C. at 1° C. per one minute. At the same temperature, the reaction occurs for three hours to harden the above components, whereby a core particle 11 was produced.

A composition and production conditions of each of the core particles are indicated in the following Table 2.

TABLE 2

| | | | | | | Pulverization | Temperature of | | Particle size | |
|---|---|---|---|---|---|---|---|---|---|---|
| Core | | | | | | time (hour) | main | Time of main | after | |
| particle | Composition (mol %) | | | | | after temporary | calcinations | calcinations | classification | |
| No. | MnO | MgO | Fe₂O₃ | SrO | SiO₂ | calcinations | (° C.) | (hour) | (μm) | Remarks |
| 1 | 35 | 14.5 | 50 | 0.5 | 0 | 5 | 1300 | 5 | 24.2 | |
| 2 | 35 | 14.5 | 50 | 0.5 | 0 | 5 | 1300 | 5 | 12.5 | |
| 3 | 35 | 14.5 | 50 | 0.5 | 0 | 5 | 1300 | 5 | 14.3 | |
| 4 | 35 | 14.5 | 50 | 0.5 | 0 | 5 | 1300 | 5 | 19 | |
| 5 | 35 | 14.5 | 50 | 0.5 | 0 | 5 | 1300 | 5 | 32 | |
| 6 | 35 | 14.5 | 50 | 0.5 | 0 | 5 | 1300 | 4 | 24.2 | |
| 7 | 35 | 14.5 | 50 | 0.5 | 0 | 5 | 1200 | 4 | 24.2 | |
| 8 | 35 | 14.5 | 50 | 0.5 | 0 | 5 | 1150 | 4 | 24.2 | Porous |
| 9 | 0 | 39.5 | 50 | 0.5 | 10 | 5 | 1300 | 5 | 24.2 | |
| 10 | 49.5 | 0 | 50 | 0.5 | 0 | 5 | 1300 | 5 | 24.2 | |
| 11 | — | — | — | — | — | — | — | — | 24.2 | Polymerization |
| | | | | | | | | | | carrier |
| 12 | 35 | 14.5 | 50 | 0.5 | 0 | 7 | 1250 | 8 | 24.2 | |
| 13 | 35 | 14.5 | 50 | 0.5 | 0 | 5 | 1350 | 5 | 24.2 | |
| 14 | 35 | 14.5 | 50 | 0.5 | 0 | 8 | 1250 | 8 | 24.2 | |
| 15 | 35 | 14.5 | 50 | 0.5 | 0 | 3 | 1350 | 5 | 24.2 | |

(Production of Resin for Coating 1)

Cyclohexyl methacrylate (CHMA) and methyl methacrylate (MMA) were added into 0.3 mass % of aqueous sodium benzenesulfonate solution at a ratio (mass ratio, copolymerization ratio) of 50:50, and further thereto, potassium persulfate was added in an amount of 0.5 mass % of the total amount of the monomers to perform emulsion polymerization, followed by being dried by a spray drier, whereby a resin for coating 1 (CHMA-MMA) was produced. The thus obtained resin for coating 1 exhibited a weight-average molecular weight of 500,000.

(Production of Resin for Coating 2)

A resin for coating 2 was produced in the same manner as in the production of the resin for coating 1 except that styrene was used instead of the cyclohexyl methacrylate. The thus obtained resin for coating 2 exhibited a weight-average molecular weight of 600,000.

(Production of Carrier Particle 1)

Into a high-speed stirring mixer with a horizontal rotary blade, 100 parts by mass of the “core particle 1” as a core particle prepared above and 3.5 parts by mass of the “resin for coating 1” were introduced, and were stirred for 15 minutes at 22° C. under a condition that a peripheral speed of the horizontal rotary blade was 8 m/sec. Thereafter, mixing was further conducted at 120° C. for 50 minutes to coat the surfaces of the core particles with the resin for coating 1 by the action of mechanical impact force (mechanochemical method), whereby a “carrier particle 1” was obtained. The thickness of the resin-coated layer on the surface of the core particles was 0.4 μm.

(Production of Carrier Particle 2)

Straight silicone (SR-2411 manufactured by Dow Corning Toray Co., Ltd.) was weighed by 3.5 parts by mass in terms of a solid content and dissolved in 1000 parts by mass of a toluene solvent, whereby a coating liquid including a resin for coating was prepared.

The core particle 1 was coated with the prepared coating liquid using a fluidized bed coating apparatus, and was then subjected to a baking treatment at 250° C. for two hours, so that the coagulated particles were disintegrated and a carrier particle 2 was produced by the adjustment of the particle size. The thickness of the resin-coated layer on the surface of the core particles was 0.4 μm.

(Production of Carrier Particle 3)

A carrier particle 3 was produced in the same manner as in the production of the carrier particle 1 except that a “resin for coating 2” was employed instead of the “resin for coating 1”.

(Production of Carrier Particles 4 to 7, and 12 to 21)

Carrier particles 4 to 7, and 12 to 21 were produced in the same manner as in the production of the carrier particle 1 except that core particles indicated in Table 3 were used instead of the core particle 1.

(Production of Carrier Particle 8)

A carrier particle 8 was produced in the same manner as in the production of the carrier particle 1 except that the amount of “resin for coating 1” to be introduced was 2.5 parts by mass. The thickness of the resin-coated layer on the surface of the core particles was 0.3 μm.

(Production of Carrier Particle 9)

A carrier particle 9 was produced in the same manner as in the production of the carrier particle 1 except that the amount of “resin for coating 1” to be introduced was 4.5 parts by mass. The thickness of the resin-coated layer on the surface of the core particles was 0.5 μm.

(Production of Carrier Particle 10)

A carrier particle 10 was produced in the same manner as in the production of the carrier particle 1 except that the amount of “resin for coating 1” to be introduced was 2 parts by mass. The thickness of the resin-coated layer on the surface of the core particles was 0.25 μm.

(Production of Carrier Particle 11)

A carrier particle 11 was produced in the same manner as in the production of the carrier particle 1 except that the amount of “resin for coating 1” to be introduced was 5 parts by mass. The thickness of the resin-coated layer on the surface of the core particles was 0.55 μm.

(Porosity of Core Particles)

The porosity of the core particles is obtained in such a manner that an image obtained after a cross-section of the core particles is taken by a scanning type electron microscope is analyzed using image analysis software (Image-Pro Plus manufactured by Media Cybernetics Inc.). Specifically, an area (A) of particles which are connected by a line enveloping the unevenness of the surface of the core particles is measured, and subsequently, an area (B) of a core portion contained in a screen of the core particles is measured. Here, the porosity is calculated using the following Formula (1).

[Formula 7]

Porosity (%)=(Enveloping particle area (A)−Core area (B))/Enveloping particle area (A)×100 (1)

The porosity calculated by the Formula (1) is a porosity obtained in combination of a gap which is continuous from the surface of the core particles and a gap which independently exists inside the core particles.

More specifically, with respect to ten of core particles, images obtained after cross sections in the vicinity of the center are taken by the scanning type electron microscope are analyzed to obtain an average value. Then, the porosity can be determined from the average value.

(Volume-Average Particle Size of Carrier Particles)

The volume-average particle size (D₅₀) of the carrier particles is a measured in a wet manner using a laser diffraction-type particle size distribution measuring apparatus “HEROS KA” (manufactured by Japan Laser Corp.). Specifically, first, an optical system having a focal position of 200 mm is selected, and a measurement time is set to five seconds. Then, magnetic particles for measurement are added to 0.2% dodecyl sodium sulfate aqueous solution and are dispersed therein for three minutes using an ultrasonic washing machine “US-1” (manufactured AS ONE Corp.), whereby a sample dispersion liquid for measurement is produced. Several droplets of the sample dispersion liquid are supplied to the “HEROS KA” to start measurement at the time when a sample concentration gauge reaches a measurable region. With respect to a particle-size range (channel) of the obtained particle size distribution, cumulative distribution is created from a small size side. Then, the particle size corresponding to 50% of the cumulative distribution was defined as a volume-average particle size (D₅₀).

(Volume Resistivity of Carrier Particles)

The magnetic brush was formed in such a manner that a photosensitive drum was replaced by an electrode drum made of aluminum having the same dimension as the photosensitive drum and the carrier particles were supplied onto a developing sleeve. This magnetic brush was rubbed with the electrode drum made of aluminum, a voltage (500 V) was applied between the developing sleeve and the drum, thereby measuring a current flowing between the developing sleeve and the drum. Thus, the volume resistivity of the carrier particles could be obtained by the following Formula (2).

[Formula 8]

DVR (Ω·cm)=(V/I)×(N×L/Dsd) (2)

DVR: Volume resistivity of carrier (Ω·cm)

V: Voltage between developing sleeve and drum (V)

I: Measured current value (A)

N: Width of developing nip (cm)

L: Length of developing sleeve (cm)

Dsd: Distance between developing sleeve and drum (cm)

In the present invention, the measurement are performed with V=500 V, N=1 cm, L=6 cm, and Dsd=0.6 mm.

(True Specific Gravity of Carrier Particles)

A true specific gravity of carrier particles was measured by a true density measuring machine (VOLUMETER. VM-100 type manufactured by S-TEC Co., Ltd.).

(Shape Factor SF-1)

A shape factor (SF-1) of the carrier particles is a numerical value calculated by the following Formula (3).

[Formula 9]

SF-1=[{(Maximum length of particle)²/(Projection area of particle)}×(π/4)]×100 (3)

<<Measurement Method>>

By the scanning type electron microscope, 100 or more carrier particles are randomly photographed at 150 times, and the photographed images are received by a scanner. The received images are analyzed using an image processing analyzer “LUZEX AP” (manufactured by NIRECO Corporation), and the maximum length and a projected area are determined for each of the carrier particles, whereby the shape factor SF-1 is calculated using Formula (3) described above. An average value of the shape factor SF-1 calculated for each of the particles was referred to a “shape factor SF-1” in the present invention.

Configuration and physical properties of the carrier particles are indicated in Table 3 below.

TABLE 3

| | | | | Volume | | | |
|---|---|---|---|---|---|---|---|
| Carrier | Core particles | Porosity of core | Volume-average | resistivity | True specific | Shape factor | Resin for |
| particles No. | No. | particles (%) | particle size (μm) | (Ω · cm) | gravity (g/cm³) | SF-1 | coating |
| 1 | 1 | 5 | 25 | 1 × 10⁹ | 4.5 | 115 | CHMA-MMA |
| 2 | 1 | 5 | 25 | 1 × 10⁹ | 4.5 | 115 | Silicone resin |
| 3 | 1 | 5 | 25 | 1 × 10⁹ | 4.5 | 115 | ST-MMA |
| 4 | 3 | 5 | 15 | 1 × 10⁹ | 4.5 | 115 | CHMA-MMA |
| 5 | 4 | 5 | 30 | 1 × 10⁹ | 4.5 | 115 | CHMA-MMA |
| 6 | 2 | 5 | 13 | 1 × 10⁹ | 4.5 | 115 | CHMA-MMA |
| 7 | 5 | 5 | 33 | 1 × 10⁹ | 4.5 | 115 | CHMA-MMA |
| 8 | 1 | 5 | 24.8 | 1 × 10⁸ | 4.5 | 115 | CHMA-MMA |
| 9 | 1 | 5 | 25.2 | 1 × 10¹⁰ | 4.5 | 115 | CHMA-MMA |
| 10 | 1 | 5 | 24.7 | 5 × 10⁷ | 4.5 | 115 | CHMA-MMA |
| 11 | 1 | 5 | 25.3 | 5 × 10¹⁰ | 4.5 | 115 | CHMA-MMA |
| 12 | 6 | 8 | 25 | 1 × 10⁹ | 4.5 | 115 | CHMA-MMA |
| 13 | 7 | 15 | 25 | 1 × 10⁹ | 4.5 | 115 | CHMA-MMA |
| 14 | 8 | 30 | 25 | 1 × 10⁹ | 4.5 | 115 | CHMA-MMA |
| 15 | 9 | 5 | 25 | 1 × 10⁹ | 4.25 | 115 | CHMA-MMA |
| 16 | 10 | 5 | 25 | 1 × 10⁹ | 5 | 115 | CHMA-MMA |
| 17 | 11 | 5 | 25 | 1 × 10⁹ | 4.1 | 115 | CHMA-MMA |
| 18 | 12 | 5 | 25 | 1 × 10⁹ | 4.5 | 105 | CHMA-MMA |
| 19 | 13 | 5 | 25 | 1 × 10⁹ | 4.5 | 125 | CHMA-MMA |
| 20 | 14 | 5 | 25 | 1 × 10⁹ | 4.5 | 102 | CHMA-MMA |
| 21 | 15 | 5 | 25 | 1 × 10⁹ | 4.5 | 130 | CHMA-MMA |

<Production of Developer 1>

The toner particle 1 and the carrier particle 1 produced as described above were mixed such that the toner concentration became 5 mass %, whereby a developer 1 was produced. The mixing was performed at 25° C. for 30 minutes using a V-type mixer as a mixer (manufactured by TOKUJU Corporation).

<Production of Developers 2 to 28>

Developers 2 to 28 were produced in the same manner as in the production of developer 1 except that the toner particles and the carriers were combined with each other as indicated in Tables 4 and 5 below.

(Evaluation)

An evaluation apparatus employed a commercially available digital full-color multifunction printer “bizhub PRO (registered trademark) C6500” (manufactured by Konica Minolta, Inc.). Each of the foregoing developers was sequentially loaded in the apparatus, and printing of forming a belt-like solid image as a test image at a print ratio of 5% was conducted on 100,000 sheets of A4-size high-quality paper (65 g/m²) under an environment of high temperature and high humidity (30° C., 80% RH of relative humidity).

<Density Unevenness>

After 100,000 sheets were printed, 100 sheets of A4-size recording paper having a halftone dot image of 40% with respect to the entire surface were continuously printed. Then, a reflection density of the image on the first sheet and a reflection density of the image on the 100-th sheet were measured by a MacBeth reflection densitometer “RD907” (manufactured by MacBeth Co., Ltd.), and the unevenness of image density was evaluated by a density difference between the first sheet and the 100-th sheet. In this evaluation, when the density difference was 0.05 or smaller, it was determined to be acceptable.

⊙: 0.03 or smaller

◯: From larger than 0.03 to 0.05

X: Larger than 0.05.

<Image Quality (Graininess Index GI)>

After 100,000 sheets were printed, 500 sheets were further printed to form a belt-like solid image having 40% of a printing ratio, and then a gradation pattern having a gradation ratio of 32 levels was output. Graininess of this gradation pattern was evaluated according to the following evaluation criteria. The evaluation of the graininess was performed in such a manner of performing Fourier transform on a read value of the gradation pattern by CCD in consideration of correction of MTF (Modulation Transfer Function), measuring a graininess index (GI) adapted to specific visible sensitivity of human, and determining a maximum value of GI. It is preferable that the value of GI becomes smaller. The value of GI is a value that has been published in 39(2), 84 •93 (2000), Japan Image Journal. In this evaluation, when the value of GI was less than 0.195, it was determined to be acceptable.

⊙: Less than 0.170

◯: From 0.170 to less than 0.195

X: 0.195 or more.

<Fogging>

During an initial printing and after 100,000 sheets were printed, a blank sheet was printed, the evaluation was performed on a blank-sheet density of a transfer material during the initial printing and after 100,000 sheets were printed. With respect to 20 sites in A4-size transfer material was measured, a density was measured, and an average value was referred to as a blank-sheet density. The density was measured using MacBeth reflection densitometer “RD-918” (manufactured by MacBeth Co., Ltd.). When the blank-sheet density was 0.01 or less, it was determined to be acceptable.

⊙: 0.005 or less

◯: From more than 0.005 to 0.01

X: More than 0.01.

<Sleeve Memory>

A position of a developing sleeve obtained by developing an image, in which a solid white portion and a solid black portion are adjacent to each other, was present in a developing position during the next rotation of the developing sleeve, and was set to develop a halftone. A density difference which has appeared in the halftone was confirmed by visual observation, and thus the evaluation was performed by the following evaluation criteria.

⊙: Good level in which a sleeve memory is not observed with naked eyes (Density difference in image ≦0.02)

◯: Allowable level in which a sleeve memory is slightly observed with naked eyes (0.02<Density difference in image ≦0.05)

X: Practically problematic level in which a sleeve memory is clearly observed with naked eyes (Density difference in image >0.05).

A configuration and evaluation results of each developer are indicated in Tables 4 and 5 below.

TABLE 4

| | | | | | Carrier particles | | | |
|---|---|---|---|---|---|---|---|---|
| | | Toner particles | | | | Porosity | | |
| | | | Volume-average | Average | | of core | Volume-average | Volume |
| | Developer | | particle size | degree of | | particles | particle size | resistivity |
| | No. | No. | (μm) | circularity | No. | (%) | (μm) | (Ω · cm) |
| Example 1 | 1 | 1 | 4 | 0.965 | 1 | 5 | 25 | 1 × 10⁹ |
| Example 2 | 2 | 1 | 4 | 0.965 | 2 | 5 | 25 | 1 × 10⁹ |
| Example 3 | 3 | 1 | 4 | 0.965 | 3 | 5 | 25 | 1 × 10⁹ |
| Example 4 | 4 | 1 | 4 | 0.965 | 4 | 5 | 15 | 1 × 10⁹ |
| Example 5 | 5 | 1 | 4 | 0.965 | 5 | 5 | 30 | 1 × 10⁹ |
| Comparative | 6 | 1 | 4 | 0.965 | 6 | 5 | 13 | 1 × 10⁹ |
| Example 1 | | | | | | | | |
| Comparative | 7 | 1 | 4 | 0.965 | 7 | 5 | 33 | 1 × 10⁹ |
| Example 2 | | | | | | | | |
| Example 6 | 8 | 1 | 4 | 0.965 | 8 | 5 | 25 | 1 × 10⁸ |
| Example 7 | 9 | 1 | 4 | 0.965 | 9 | 5 | 25 | 1 × 10¹⁰ |
| Comparative | 10 | 1 | 4 | 0.965 | 10 | 5 | 25 | 5 × 10⁷ |
| Example 3 | | | | | | | | |
| Comparative | 11 | 1 | 4 | 0.965 | 11 | 5 | 25 | 5 × 10¹⁰ |
| Example 4 | | | | | | | | |
| Example 8 | 12 | 1 | 4 | 0.965 | 12 | 8 | 25 | 1 × 10⁹ |
| Comparative | 13 | 1 | 4 | 0.965 | 13 | 15 | 25 | 1 × 10⁹ |
| Example 5 | | | | | | | | |
| Comparative | 14 | 1 | 4 | 0.965 | 14 | 30 | 25 | 1 × 10⁹ |
| Example 6 | | | | | | | | |

| | Carrier particles | | | | | | |
|---|---|---|---|---|---|---|---|
| | True | | | | | | |
| | specific | Shape | Resin | Evaluation result | | | |
| | gravity | factor | for | Density | Value of | | Sleeve |
| | (g/cm³) | SF-1 | coating | unevenness | GI | Fogging | memory |
| Example 1 | 4.5 | 115 | CHMA-MMA | ⊙ 0.02 | ⊙ 0.165 | ⊙ 0.002 | ⊙ 0.01 |
| Example 2 | 4.5 | 115 | Silicone resin | ◯ 0.05 | ◯ 0.193 | ◯ 0.01 | ◯ 0.04 |
| Example 3 | 4.5 | 115 | ST-MMA | ◯ 0.05 | ◯ 0.192 | ◯ 0.008 | ◯ 0.04 |
| Example 4 | 4.5 | 115 | CHMA-MMA | ◯ 0.04 | ⊙ 0.168 | ⊙ 0.003 | ⊙ 0.02 |
| Example 5 | 4.5 | 115 | CHMA-MMA | ◯ 0.05 | ◯ 0.174 | ⊙ 0.003 | ⊙ 0.01 |
| Comparative | 4.5 | 115 | CHMA-MMA | X 0.07 | ◯ 0.178 | X 0.012 | ⊙ 0.02 |
| Example 1 | | | | | | | |
| Comparative | 4.5 | 115 | CHMA-MMA | X 0.07 | X 0.201 | ◯ 0.006 | ⊙ 0.02 |
| Example 2 | | | | | | | |
| Example 6 | 4.5 | 115 | CHMA-MMA | ◯ 0.04 | ⊙ 0.166 | ◯ 0.007 | ⊙ 0.02 |
| Example 7 | 4.5 | 115 | CHMA-MMA | ◯ 0.05 | ⊙ 0.169 | ⊙ 0.003 | ◯ 0.03 |
| Comparative | 4.5 | 115 | CHMA-MMA | X 0.08 | ◯ 0.172 | X 0.013 | ⊙ 0.01 |
| Example 3 | | | | | | | |
| Comparative | 4.5 | 115 | CHMA-MMA | ◯ 0.05 | ◯ 0.177 | X 0.017 | X 0.08 |
| Example 4 | | | | | | | |
| Example 8 | 4.5 | 115 | CHMA-MMA | ⊙ 0.02 | ⊙ 0.167 | ◯ 0.006 | ⊙ 0.02 |
| Comparative | 4.5 | 115 | CHMA-MMA | ◯ 0.05 | ◯ 0.187 | X 0.016 | ⊙ 0.02 |
| Example 5 | | | | | | | |
| Comparative | 4.5 | 115 | CHMA-MMA | X 0.06 | X 0.199 | X 0.02 | ◯ 0.05 |
| Example 6 | | | | | | | |

TABLE 5

| | | | | | Carrier particles | | | |
|---|---|---|---|---|---|---|---|---|
| | | Toner particles | | | | Porosity | | |
| | | | Volume-average | Average | | of core | Volume-average | Volume |
| | Developer | | particle size | degree of | | particles | particle size | resistivity |
| | No. | No. | (μm) | circularity | No. | (%) | (μm) | (Ω · cm) |
| Example 9 | 15 | 1 | 4 | 0.965 | 15 | 5 | 25 | 1 × 10⁹ |
| Example 10 | 16 | 1 | 4 | 0.965 | 16 | 5 | 25 | 1 × 10⁹ |
| Comparative | 17 | 1 | 4 | 0.965 | 17 | 5 | 25 | 1 × 10⁹ |
| Example 7 | | | | | | | | |
| Example 11 | 18 | 1 | 4 | 0.965 | 18 | 5 | 25 | 1 × 10⁹ |
| Example 12 | 19 | 1 | 4 | 0.965 | 19 | 5 | 25 | 1 × 10⁹ |
| Comparative | 20 | 1 | 4 | 0.965 | 20 | 5 | 25 | 1 × 10⁹ |
| Example 8 | | | | | | | | |
| Comparative | 21 | 1 | 4 | 0.965 | 21 | 5 | 25 | 1 × 10⁹ |
| Example 9 | | | | | | | | |
| Example 13 | 22 | 2 | 4 | 0.97 | 1 | 5 | 25 | 1 × 10⁹ |
| Example 14 | 23 | 3 | 4 | 0.975 | 1 | 5 | 25 | 1 × 10⁹ |
| Example 15 | 24 | 4 | 3 | 0.96 | 1 | 5 | 25 | 1 × 10⁹ |
| Example 16 | 25 | 5 | 5 | 0.96 | 1 | 5 | 25 | 1 × 10⁹ |
| Comparative | 26 | 6 | 6 | 0.96 | 1 | 5 | 25 | 1 × 10⁹ |
| Example 10 | | | | | | | | |
| Comparative | 27 | 7 | 2.8 | 0.96 | 1 | 5 | 25 | 1 × 10⁹ |
| Example 11 | | | | | | | | |
| Comparative | 28 | 6 | 6 | 0.96 | 7 | 5 | 33 | 1 × 10⁹ |
| Example 12 | | | | | | | | |

| | Carrier particles | | | | | | |
|---|---|---|---|---|---|---|---|
| | True | | | | | | |
| | specific | Shape | Resin | Evaluation result | | | |
| | gravity | factor | for | Density | Value of | | Sleeve |
| | (g/cm³) | SF-1 | coating | unevenness | GI | Fogging | memory |
| Example 9 | 4.25 | 115 | CHMA-MMA | ◯ 0.05 | ⊙ 0.167 | ⊙ 0.004 | ⊙ 0.02 |
| Example 10 | 5 | 115 | CHMA-MMA | ⊙ 0.02 | ⊙ 0.166 | ◯ 0.007 | ⊙ 0.02 |
| Comparative | 4.1 | 115 | CHMA-MMA | X 0.07 | ◯ 0.188 | ◯ 0.009 | ⊙ 0.02 |
| Example 7 | | | | | | | |
| Example 11 | 4.5 | 105 | CHMA-MMA | ◯ 0.05 | ⊙ 0.168 | ⊙ 0.005 | ◯ 0.05 |
| Example 12 | 4.5 | 125 | CHMA-MMA | ⊙ 0.02 | ⊙ 0.165 | ◯ 0.007 | ⊙ 0.02 |
| Comparative | 4.5 | 102 | CHMA-MMA | X 0.08 | ◯ 0.185 | ◯ 0.009 | X 0.09 |
| Example 8 | | | | | | | |
| Comparative | 4.5 | 130 | CHMA-MMA | ◯ 0.04 | ◯ 0.176 | X 0.012 | ⊙ 0.01 |
| Example 9 | | | | | | | |
| Example 13 | 4.5 | 115 | CHMA-MMA | ⊙ 0.03 | ⊙ 0.167 | ⊙ 0.004 | ⊙ 0.02 |
| Example 14 | 4.5 | 115 | CHMA-MMA | ◯ 0.04 | ⊙ 0.169 | ◯ 0.006 | ◯ 0.03 |
| Example 15 | 4.5 | 115 | CHMA-MMA | ⊙ 0.03 | ⊙ 0.169 | ◯ 0.007 | ⊙ 0.02 |
| Example 16 | 4.5 | 115 | CHMA-MMA | ⊙ 0.03 | ◯ 0.175 | ⊙ 0.002 | ⊙ 0.02 |
| Comparative | 4.5 | 115 | CHMA-MMA | X 0.07 | X 0.197 | ⊙ 0.004 | ◯ 0.03 |
| Example 10 | | | | | | | |
| Comparative | 4.5 | 115 | CHMA-MMA | ◯ 0.05 | X 0.201 | X 0.013 | ◯ 0.05 |
| Example 11 | | | | | | | |
| Comparative | 4.5 | 115 | CHMA-MMA | ◯ 0.05 | X 0.205 | ◯ 0.006 | ◯ 0.04 |
| Example 12 | | | | | | | |

As can be apparent from Tables 4 and 5 above, in the case of using the two-component developers according to Examples, the density unevenness and the fogging were reduced, and thus it was found that a high-quality image having excellent dot reproducibility could be obtained. In addition, it was found that the sleeve memory could be also reduced. Thus, it was found that when the two-component developer according to the present invention was used, the rising of charge amount of the toner particles was improved, the charging property of the toner particles could be stably maintained, and particularly the high-quality image could be obtained for a long period in the continuous printing with high image density.

Although the present invention has been described and illustrated in detail, it is clearly understood that the same is by way of illustrated and example only and is not to be taken byway of limitation, the scope of the present invention being interpreted by terms of the appended claims.

What is claimed is:

1. A two-component developer for electrostatic latent image development comprising:
toner particles obtained in such a manner that an external additive is attached to a surface of toner base particles containing at least a binder resin; and
carrier particles obtained in such a manner that a surface of core particles is coated with a resin for coating, wherein
the toner particles have a volume-average particle size of 3 μm or more and 5 μm or less,
the core particles have porosity of 8% or less, and
the carrier particles have a volume-average particle size of 15 μm or more and 30 μm or less, volume resistivity of 1×10⁸ Ω·cm or more and 1×10¹⁰ Ω·cm or less, a true specific gravity of 4.25 g/cm³ or more and 5 g/cm³ or less, and a shape factor SF-1 of 105 or more and 125 or less.

2. The two-component developer for electrostatic latent image development according to claim 1, wherein
the binder resin contains at least a crystalline polyester resin.

3. The two-component developer for electrostatic latent image development according to claim 1, wherein
the resin for coating contains a constituent unit derived from an alicyclic (meth)acrylic acid ester compound.

4. The two-component developer for electrostatic latent image development according to claim 1, wherein the toner particles have an average degree of circularity of 0.970 or less.

5. The two-component developer for electrostatic latent image development according to claim 1, wherein the core particles are ferrite particles containing at least one of manganese and magnesium.

6. The two-component developer for electrostatic latent image development according to claim 1, wherein the core particles have porosity of 5% or less.

7. The two-component developer for electrostatic latent image development according to claim 1, wherein the carrier particles have a volume-average particle size of 18 μm or more and 28 μm or less.

8. The two-component developer for electrostatic latent image development according to claim 1, wherein the carrier particles have volume resistivity of 5×10⁸ Ω·cm or more and 5×10⁹ Ω·cm or less.

9. The two-component developer for electrostatic latent image development according to claim 1, wherein the carrier particles have a true specific gravity of 4.4 g/cm³ or more and 4.8 g/cm³ or less.

10. The two-component developer for electrostatic latent image development according to claim 1, wherein the carrier particles have a shape factor SF-1 of 110 or more and 120 or less.

11. The two-component developer for electrostatic latent image development according to claim 1, wherein the toner particles have a volume-average particle size of 3.5 μm or more and 4.5 μm or less

12. The two-component developer for electrostatic latent image development according to claim 1, wherein the resin for coating contains a constituent unit derived from an alicyclic (meth)acrylic acid ester compound having a cycloalkyl group in which the number of carbon is 5 to 8.

13. The two-component developer for electrostatic latent image development according to claim 3, wherein the constituent unit derived from an alicyclic (meth)acrylic acid ester compound is contained in the resin for coating in a ratio of 30 to 70 mass %.

14. The two-component developer for electrostatic latent image development according to claim 1, wherein the resin for coating has a weight-average molecular weight that is in a range of 200,000 to 800,000.
